(19) United States
(12) Patent Application Publication
(10) Pub. No.: US 2026/0278898 A1
(43) Pub. Date: Sep. 17, 2026

(54) SYSTEM AND METHOD FOR CONSISTENT FRAME GENERATION

(71) Applicant: Intangible Technology Inc., San Francisco, CA (US)

(72) Inventors: Charles Migos, San Francisco, CA (US); Bharadwaj Srinivasan, San Francisco, CA (US); Joshua Chanthavisay, San Francisco, CA (US)

(73) Assignee: Intangible Technology Inc., San Francisco, CA (US)

(21) Appl. No.: 19/565,364

(22) Filed: Mar. 12, 2026

Related U.S. Application Data
(60) Provisional application No. 63/770,888, filed on Mar. 12, 2025.
(60) Provisional application No. 63/813,188, filed on May 28, 2025.

(51) Int. Cl. G06T 13/20; G06T 15/20

(52) U.S. Cl. CPC G06T 13/20; G06T 15/20

(57) ABSTRACT

The method can include: defining a 3D scene representation including a set of 3D object models, wherein each object model is associated with a set of object attributes (e.g., relative pose, object descriptions, visual references, etc.); defining one or more frame sets; defining a set of visual settings for each frame set; and generating colorized versions of each frame set by prompting a generative model with the 3D scene representation, the object attributes, and the visual settings; and generating a video based on the one or more frame sets.

### CROSS-REFERENCE TO RELATED APPLICATIONS

This application claims the benefit of US Provisional Application number 63/770,888 filed 12 Mar. 2025 and US Provisional Application number 63/813,188 filed 28 May 2025, each of which is incorporated in its entirety by this reference.

### TECHNICAL FIELD

This invention relates generally to the generative AI field, and more specifically to a new and useful system and method for ensuring consistent, coherent, and continuous inter-frame generation in the generative AI field.

### BRIEF DESCRIPTION OF THE FIGURES

FIG. 1 is a schematic representation of a variant of the method.

FIG. 2 is a schematic representation of a variant of S300.

FIG. 3 is a schematic representation of a variant of the method.

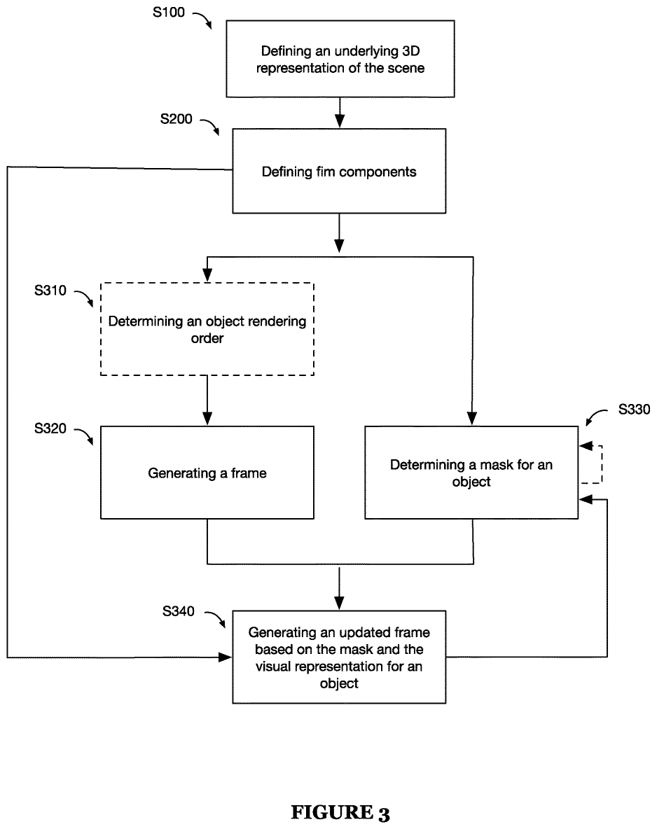

FIG. 4 is a schematic representation of a variant of generating a series of coherent frames using a generative model.

FIG. 5 is an illustrative example of generating a frame using a scene representation and a set of visual settings.

FIG. 6 is an illustrative example of a film definition interface.

FIG. 7 is an illustrative example of a frame generated using the method.

FIG. 8 is an illustrative example of selecting an object in the generated frame, corresponding to an underlying object in the scene representation.

FIG. 9 is an illustrative example of setting object attributes for a first and second object (character).

FIG. 10 is a first illustrative example of S300, wherein the object mask for the next object is iteratively generated.

FIG. 11 is a second illustrative example of S300, wherein the object masks for the objects are generated independently from frame generation.

FIG. 12 is an illustrative example of updating a frame based on an updated visual representation.

FIG. 13 is a schematic representation of a variant of the system.

### DETAILED DESCRIPTION

The following description of the embodiments of the invention is not intended to limit the invention to these embodiments, but rather to enable any person skilled in the art to make and use this invention.

### 1. Overview

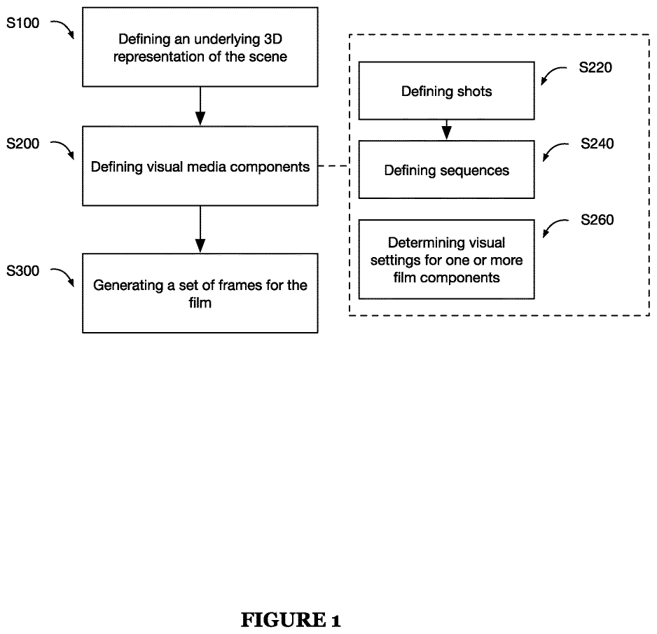

As shown in FIG. 1, variants of the method can include: defining an underlying 3D representation S100; defining visual media components S200; and generating a set of frames for the visual media S300. The method functions to maintain interframe consistency, coherence, and continuity when using generative AI to generate multiframe assets (e.g., films, videos, etc.). Variants of the system can include a database 100; an user interface 200; and a set of modules. The set of modules can include a frame generation model 300, a mask generator 400, a video generation model 500, and/or any other modules.

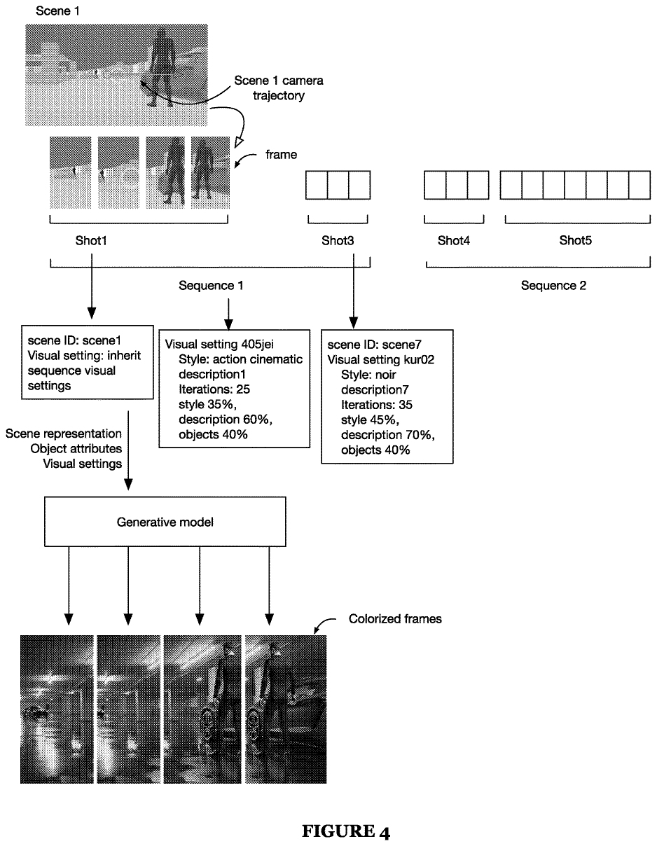

In an illustrative example, the method can include: defining a 3D scene representation including a set of 3D object models, wherein each object model is associated with a set of object attributes (e.g., relative pose, object descriptions, interactions with other objects within the environment, object appearance, style, etc.); defining one or more frame sets (e.g., shots, sequences, etc.), wherein each frame in a frame set depicts a perspective of the scene; defining a set of visual settings (e.g., including style descriptions, diffusion settings, etc.) for each frame set; and generating colorized versions of each frame set by prompting a generative AI model (e.g. diffusion model) with the 3D scene representation (or 2D projection thereof), the object attributes, and the visual settings. An example is shown in FIG. 4.

In examples, the frames can optionally be regenerated by the generative AI model using different: visual settings, virtual environments (e.g., object set, object configurations, etc.), object attributes (e.g., descriptions, animations, timing, etc.), shot parameters (e.g., camera trajectories, etc.), and/or other information. In an illustrative example, a user can change the visual settings (e.g., style, etc.) of a shot, and the frame set can be regenerated using the prior 3D scene representation, the prior object attributes, the prior diffusion settings, and the new style to maintain geometric and character consistency (e.g., across frame sets) while varying the visual style. In another illustrative example, a user can change the 3D scene representation's composition (e.g., object types, object models, object arrangement, etc.) and/or the object attributes (e.g., animation, timing, storyline, etc.), and regenerate the frame set using the new 3D scene representation and/or new object attributes, the prior visual settings (e.g., diffusion settings, style, etc.) to maintain stylistic consistency (e.g., across frame sets) while varying the geometric composition.

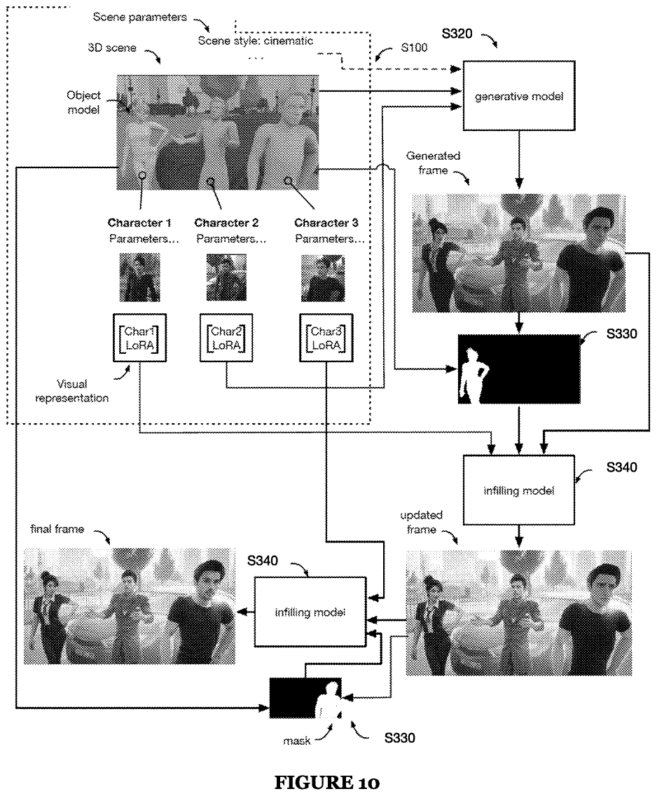

In an illustrative example, the method can include: defining a 3D scene representation including a set of object models cooperatively forming a 3D scene, wherein different object models are associated with different visual representations (e.g., reference images, LoRAs); generating a colorized frame using a generative model, based on the 3D scene and a first visual representation for a first object; and sequentially re-rendering different segments of the frame corresponding to each of the remaining objects by iteratively: determining an object mask for the next object by projecting the respective object model, from the 3D scene, into the frame; and updating the frame by prompting an infilling model to infill the object mask using the visual representation (e.g., LoRA, reference image, etc.) for the next object. An illustrative example is shown in FIG. 10. However, the system/method can be otherwise performed.

However, the method can be otherwise performed.

### 2. Technical advantages

Variants of the technology can confer one or more advantages over conventional technologies.

First, variants of the technology can address fundamental limitations in conventional generative AI video models related to temporal and physical consistency. Traditional frame-by-frame generation approaches can produce inconsistent results due to their inability to maintain context between sequential frames, leading to discontinuities in object positions, lighting conditions, and visual elements. For example, conventional systems may generate frames where objects appear to teleport between positions or exhibit physically impossible movements, degrading the quality and realism of the generated video sequence. This limitation can result in outputs that fail to meet professional quality standards and require extensive manual correction.

Second, variants of the technology can enhance video generation quality through the implementation of 3D scene-based constraints. By utilizing an underlying 3D scene representation, the system can maintain geometric and spatial relationships between objects, camera positions, and lighting conditions throughout the video sequence. In a specific example, the technology can extract geometric representations for each frame from the 3D scene model, where the generative AI model can be constrained to colorizing pre-defined object boundaries or utilizing specific object anchors. This approach can prevent physically impossible object behaviors and maintain proper spatial relationships, resulting in more naturalistic and coherent video outputs. Variants of the technology can utilize the underlying 3D representation as a structural ground truth for video generation, thereby enforcing temporal and/or physical consistency across an entire video sequence. Rather than generating frames independently or relying solely on learned latent correlations, the system can constrain frame synthesis according to persistent 3D geometry, object coordinates, camera trajectories, lighting parameters, and/or other aspects defined in the 3D representation. In this manner, the 3D representation can, in some embodiments, function as a governing data structure that defines permissible spatial configurations over time. By anchoring video generation to this structural reference, variants of the system can prevent geometric drift, perspective inconsistencies, and cumulative temporal errors that commonly arise in conventional generative video models.

Third, variants of the technology can ensure object persistence across frames by associating each rendered element with a persistent object identifier derived from the 3D representation. For example, each object within the 3D representation can maintain a stable identity that propagates through successive frames, such that pixels, regions, or feature representations generated in 2D remain linked to the same underlying object instance over time. This persistent mapping of these examples can enable consistent object appearance, motion continuity, material properties, occlusion behavior, and/or otherwise persist throughout a shot, across multiple shots, and/or across extended video sequences. By guaranteeing that objects do not lose identity between frames, examples of the system can maintain continuity that extends beyond single-frame rendering and supports long-range temporal coherence in video generation.

Fourth, variants of the technology can improve visual consistency across frame sequences through the enforcement of unified visual settings. By ensuring that each frame within a frame set can be associated with the same stylistic descriptions and diffusion settings, the system can maintain consistent visual appearance throughout the generated video. For example, if a particular artistic style or visual effect can be applied to one frame, the same parameters can be maintained across subsequent frames, preventing unwanted variations in appearance or style. This consistency can lead to more professional-looking outputs that maintain a cohesive visual identity throughout the video sequence. Variants of the technology can implement a hierarchical cascade of stylistic and generative parameters across multiple levels of video structure. Style attributes, visual definitions, and generative settings can be defined at a project level (e.g., film-wide, video, etc.), scene level, shot sequence level, individual shot level, and/or object level. These parameters can propagate downward through the hierarchy, while still permitting localized overrides. For example, a global cinematic style can be defined for an entire project, refined at the scene level for environmental tone, further adjusted at the shot level for camera-specific aesthetics, and selectively modified for individual objects. This hierarchical control structure can maintain cohesive visual identity across extended video content while enabling controlled variation, thereby improving consistency across complex, multi-shot video productions.

Fifth, variants of the technology can enable region-level (e.g., object) regeneration within a generated video sequence. In some examples, because each frame can remain structurally linked to the 3D representation and associated object identities, individual objects, regions, or segments of a frame can be selectively re-rendered without regenerating the entire frame or sequence. For example, when a specific object exhibits visual artifacts or requires refinement, the system can regenerate only the pixels associated with that object while preserving the remaining frame content and maintaining temporal alignment with adjacent frames. This selective regeneration capability can improve computational efficiency, reduce unnecessary variation, enhance fine-grained control over video output, and/or otherwise support iterative refinement of generated video content (e.g., achieving a professional-grade).

Sixth, variants of the technology can generate consistent multi-character frames, even when using distinct visual representations for each character. This can be particularly useful when LoRAs are used as character visual representations. Conventionally, a single frame cannot be generated using multiple LoRAs due to each LoRA's distinct parameter spaces, frames generated from multiple LoRAs lead to conflicting model parameter weights, which causes chimera characters to be rendered instead of distinct likenesses. In variants, this technology can solve this challenge by serializing character generation and rendering a single character during each generation pass (e.g., using only the respective LoRA for the individual character being rendered), which collectively generates the multi-character frame.

Seventh, variants of the technology can further automate multi-character frame generation by leveraging 3D scene models (e.g., used to generate the frame and aligned with the frame) to create precise character masks. This can enable sequential pixel-accurate inpainting passes while maintaining consistency (e.g., lighting consistency, style consistency, etc.) across the frame. The technology's use of 3D scene data allows for accurate masking even with overlapping or partially occluded characters, while preserving spatial relationships and lighting conditions from the initial render through subsequent character modification passes.

Eighth, variants of the technology can enable composite visual media generation using mixed foundational models and mixed-modal input data. In some embodiments, the system can utilize multiple generative and/or rendering models within a single frame generation pipeline, where different models are configured to render different object classes, scenes, materials, and/or visual styles. For example, specialized models can be used to render humans, vehicles, environmental elements, animals, and/or other scene components, with each model generating the portions of a frame corresponding to the objects for which it is configured. In addition, the system can combine multiple modalities of conditioning data on a per-object basis, including models, LoRA matrices, reference images, reference video segments, semantic metadata, style parameters, and/or material definitions. These heterogeneous inputs can be associated with objects in the underlying 3D representation and combined during rendering to produce a composite frame. This cascading structure can enable flexible integration of multiple models and data modalities within a unified rendering pipeline while maintaining coherent scene structure and visual consistency across frames.

However, further advantages can be provided by the system and method disclosed herein.

### 3. Method

As shown in FIG. 1, variants of the method can include: defining an underlying 3D representation S100; defining visual media components S200; generating a set of frames for the visual media S300; and optionally generating a video based on the set of frames S400. The method functions to maintain interframe consistency, coherence, and continuity when using generative AI to generate multiframe assets (e.g., films, videos, etc.).

All or portions of the method can be repeated (e.g., for different frame sets, for different versions of a frame set, to regenerate frame sets using different settings, etc.), performed once, iteratively, and/or performed any number of times. All or portions of the method can be performed in real time (e.g., responsive to a request), contemporaneously, concurrently, asynchronously, periodically, in series, and/or in any suitable order. All or portions of the method can be performed using a visual media definition interface (e.g., a browser-based interface, on a native application, a command-line interface, etc.), and/or using any other suitable user interface. All or portions of the method can be performed automatically, manually, semi-automatically, and/or otherwise performed. All or portions of the method can be repeated for each object associated with a visual representation within the scene construct, repeated for each object, repeated for a subset of objects, and/or performed or repeated at any other frequency.

Defining an underlying 3D representation S100 functions to define the 3D structure (e.g., compositional structure, and/or any other suitable structure) of a virtual scene. S100 can function to constrain the geometry and mechanics across frames to provide coherence and continuity. In variants, the 3D representation can act as a source of truth of the scene. For example, all downstream representations can leverage, be based on, or otherwise utilize the 3D representation. In other variants, a 2D representation (e.g., projection, image) can act as a source of truth of the scene. However, any other data representation can act as a source of truth. S100 can be performed once, performed for each shot, for each sequence, and/or at any other frequency. S100 is preferably performed by a user, but can alternatively be automatically performed (e.g., generated from a sketch or image, extracted from a predetermined 3D model, etc.), and/or otherwise performed. For example, all or portions of the underlying 3D representation can be defined by a user, predicted from an example frame (e.g., using object detection, pose detection, etc.), and/or otherwise defined. In variants the 3D representation can be retrieved, manually specified, automatically generated (e.g., based on a prompt or scene description), and/or otherwise determined. S100 can be constructed using a set of queries or requests, generated from a sample (e.g., from a sample image, a sample video, a sample model, etc.), manually specified (e.g., wherein a user drags and drops 3D object models into a scene), and/or otherwise generated. For example, the underlying 3D representation can include a 3D scene with 3D models for multiple characters. In variant, each 3D model can have a different visual representation.

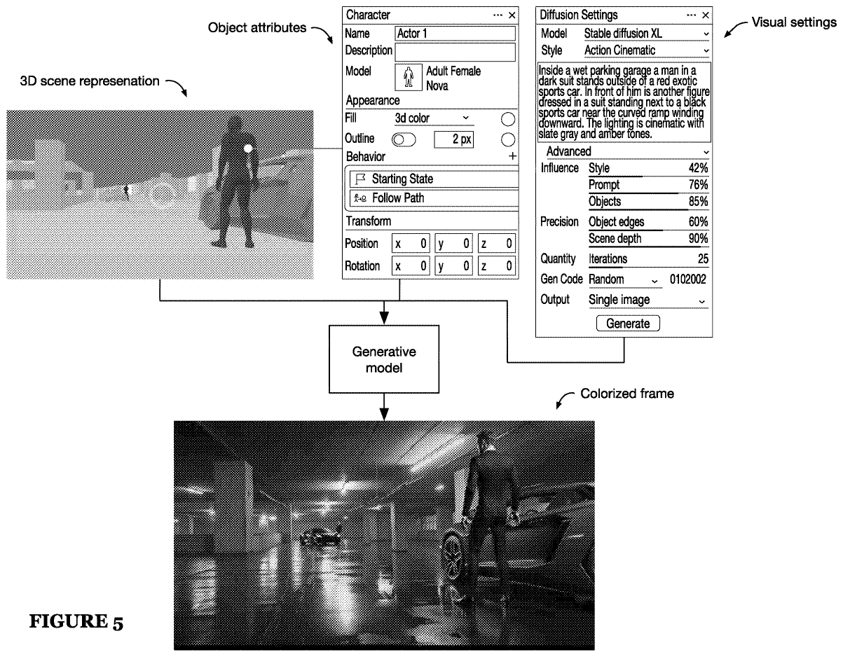

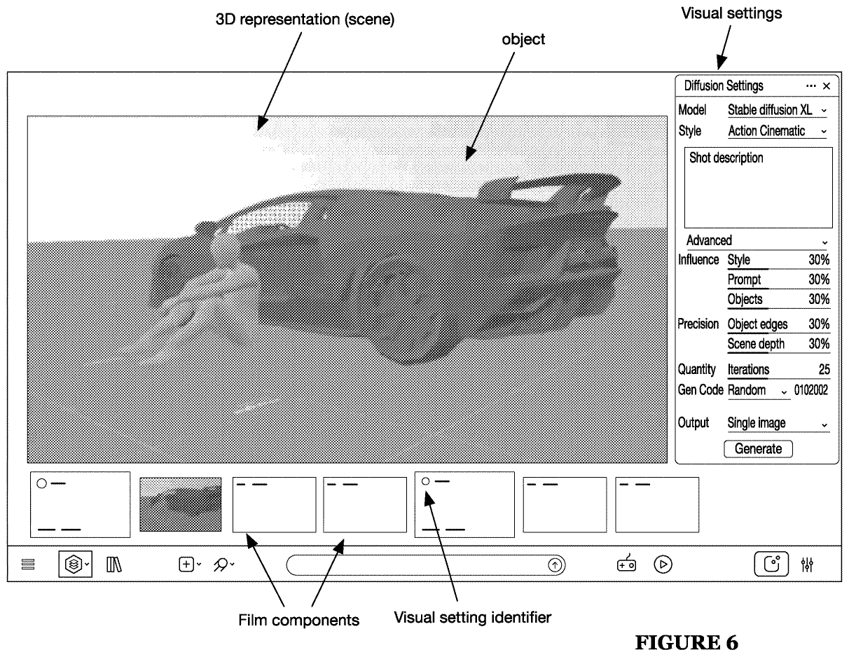

The underlying 3D representation can define a scene (e.g., 3D scene, 3D model, 3D scene representation, etc.) that can: represent the geometry and relative poses of elements in a virtual environment, constrain renderings for the object to the respective 3D model boundaries, define object masks in each frame (e.g., to identify the pixels associated with an object), and/or be otherwise used. Examples are shown in FIG. 4, FIG. 5, and FIG. 6. The underlying 3D representation can be static or dynamic (e.g., include animations of different objects within the scene).

In variants, the scene can be associated with a set of scene parameters and/or visual settings. Examples of scene parameters can include cinematographic style, artistic style (e.g., photorealistic, cartoon, anime, etc.), mood, tone, diffusion model parameters, and/or any other property. In variants, the scene parameters and/or visual settings can be inherited from the film and/or project visual setting and/or parameters. Furthermore, in variants, shots (e.g., camera trajectory perspectives of a scene) can inherit visual settings and/or scene parameters from a scene, project, and/or film visual setting definition. In another variant, visual settings assigned to a shot can be inherited by the scene, film, and/or project. In variants, this inheritance of visual settings and/or parameters can ensure visual consistency throughout a film or across shots and/or scenes.

The underlying 3D representation can include one or more virtual objects and/or object models. A virtual object (e.g., virtual element) can function to represent an atomic element and/or unit within the virtual scene, and can be an instance of an object type. The objects can be: characters, static objects, environmental objects, and/or any other suitable object. The object type can be selected from a predetermined set of object types, be a dynamically defined object type, and/or be any other object type. Each object type (e.g., “concept”) can be associated with one or more: 3D models (e.g., geometric information, geometric model(s), mesh, hull, etc.), animations, predetermined interactions with other scene elements (e.g., predefined responses, etc.), an object type identifier, and/or any other information. Examples of object types can include person, car, boat, and/or any other object types. In variants, different 3D models from the object type can be selected for inclusion within the virtual environment; alternatively, each object type can be associated with a single 3D model. The object type is preferably not associated with a visual appearance (e.g., no RGB appearance, no texture, etc.) and is preferably a skeleton or mesh, but can alternatively be associated with a default visual appearance (e.g., be colorized, have texture, etc.). For example, within the 3D representation, the object models only include geometry information (e.g., be uncolorized; shapes, volumes, relative poses, etc.). However, additionally or alternatively the object model can also include visual appearance (e.g., be colorized, visual representations, etc.) and/or other information.

Each virtual object can be associated with: a pose within the scene, an optional visual representation, scale, relationships with other object models, animations, descriptions, and/or other object parameters associated with each object model. The object parameters can be included within the 3D scene (e.g., as metadata), be separate from the 3D scene, or be otherwise defined. The object parameter values can be: manually determined, be a set of default values, determined by a model (e.g., LLM, generative model, etc.), determined based on a set of rules, and/or otherwise determined.

In variants, the underlying 3D representation can include virtual cameras, virtual light sources, and/or any other elements. In variants, the 3D representation can include virtual camera trajectories (e.g., for defining a shot, etc.). In these variants, the 3D representation can include temporal information (e.g., relating to animations, camera trajectories, etc.)

The underlying 3D representation can include one or more instances of one or more object types. A unique object instance can be associated with a set of object attributes. The set of object attributes can include: a unique object identifier, relationships with other scene elements, object descriptions, animations, object visual settings, object position, object scale, and/or other object attributes. The relationships can include physical relationships, relative pose, interaction type (e.g., sit, lean, etc.), conceptual relationships (e.g., parent, child, etc.), and/or other relationships between the object instance and the virtual environment. The object descriptions can describe how the visual appearance of the object should be rendered, how the element should interact with other elements, and/or describe other parameters of the object instance.

The descriptions can include text (e.g., text prompts), example visual representations (e.g., frames, renderings, images, etc.), qualitative parameters, and/or other descriptions. Examples of descriptions can include: persona/storyline, descriptions of relationships with other elements (for a single point in time, over a shot, scene, etc.), appearance (e.g., “zombie”, “alien”, etc.), behavior, intelligence, and/or other descriptions.

The animations can define how the object instance changes across frames. Animations can include a series of poses, series of interactions with other objects, and/or other animations. Animations can include macro animations (e.g., animations of the macro components of an object, such as arms, bodies, etc.), micro animations (e.g., animations of object features, such as facial expressions, ear movements, hair movement, etc.), and/or other animations. The animations are preferably passed directly to the generative model, but can alternatively be not passed to the generative model (e.g., wherein the animation is skinned using the output of the generative model) and/or otherwise used. In a first variant, the animations (e.g., object configuration changes over time) can be explicitly modeled as part of the 3D scene representation. In a second variant, the animations can be described (e.g., as expressions, such as “she grimaced”; as verbs, such as “wind flowed through his long hair”; etc.) as text, as video, or in any other modality. In an illustrative example, direct object instance animations (e.g., modeling an object instance dancing) can be passed directly to the generative model (e.g., as a series of 3D representation frames), while animated expressions (e.g., happy, sad, fearful, etc.) are not directly animated as part of the 3D representation, but are passed as instructions or script to the generative model, wherein the generative model interprets the instructions and generates the object instance's visual appearance (and/or modify the object instance's geometric configurations) based on said instructions.

The object visual settings function to define how the object appearance will be generated in the final frame. The object visual settings can include: appearance descriptions, visual style (e.g., noir, animation, etc.), diffusion settings, other generation settings, and/or any other visual settings. The object visual settings are preferably defined on a per-element level, but can alternatively be inherited from other elements in the environment, from the scene, from the visual media shot, from the visual media sequence, and/or any from other sources. The object attributes can also include attributes inherited from the object type (e.g., 3D model, animations, interactions with other scene elements, etc.), and/or any other attributes. The object attributes are preferably defined by a user, but can alternatively be inherited from the generic object type or otherwise defined. The optional visual settings can be for the entire object or a portion thereof (e.g., face, hair, skin, shirt, pants, cloak, shoes, etc.). In variants, object visual settings can include natural language description, images, Low-Rank Adaptation (LoRA) matrices, and/or any other data.

In variants, the underlying 3D representation (e.g., scene) can also define different environment regions (e.g., foreground, background, midground, left, middle, right, etc.). Different environment regions can be associated with the same or different visual settings, lighting parameters, and/or any other parameters. In an example, lighting parameters can include light pose, diffusion, color, hue, saturation, etc. The environment regions can be different from or inherited from the elements in the environment, from the visual media scene, from the visual media shots, and/or any other sources.

In variants, defining an underlying 3D representation S100 can include: identifying object types to include in the scene; adding 3D model instances of the identified object types to the scene; determining a set of object attributes for each object instance; and/or otherwise defining the underlying 3D representation. In variants, defining an underlying 3D representation can include any of the steps disclosed in U.S. application Ser. No. 19/424,937 filed 18 Dec. 2025, titled “RAPID VISUAL ASSET CREATION SYSTEM”, which is incorporated herein in its entirety by this reference.

Identifying object types to include in the scene functions to determine what elements to populate the scene with. Identifying object types to include in the scene can be performed manually, automatically (e.g., by an LLM), and/or otherwise identified.

In a first variant, identifying object types can include receiving a prompt to add objects to the scene (e.g., “generate a forest”, “add a person leaning against a Bugatti”, etc.), and automatically identifying object types (e.g., trees, animals, bushes, rivers, soil, etc.) based on the prompt (e.g., using a lookup table, prompting an LLM to return object types associated with the prompt, etc.).

In a second variant, identifying object types can include receiving an object type selection from a user (e.g., via a user selection of the 3D model associated with the object type, etc.).

However, identifying object types to include in the scene may be otherwise performed.

Adding 3D model instances of the identified object types to the scene functions to populate the virtual scene, wherein the object 3D model instances are arranged within the scene with a relationship (e.g., object instance pose, position, orientation, interaction, etc.) relative to another element in the scene (e.g., a scene reference point, another object model within the scene, etc.), an object configuration (e.g., arms raised, sitting, etc.), and/or any other object arrangement. The object model arrangement can be determined by the user (e.g., from a user selection of the target object pose, from a position that the user dragged-and-dropped the object instance to, etc.), randomly, based on a set of rules, based on a pose for the object determined by an LLM, and/or any other determination method. However, 3D model instances of the identified object types can be otherwise added to the scene.

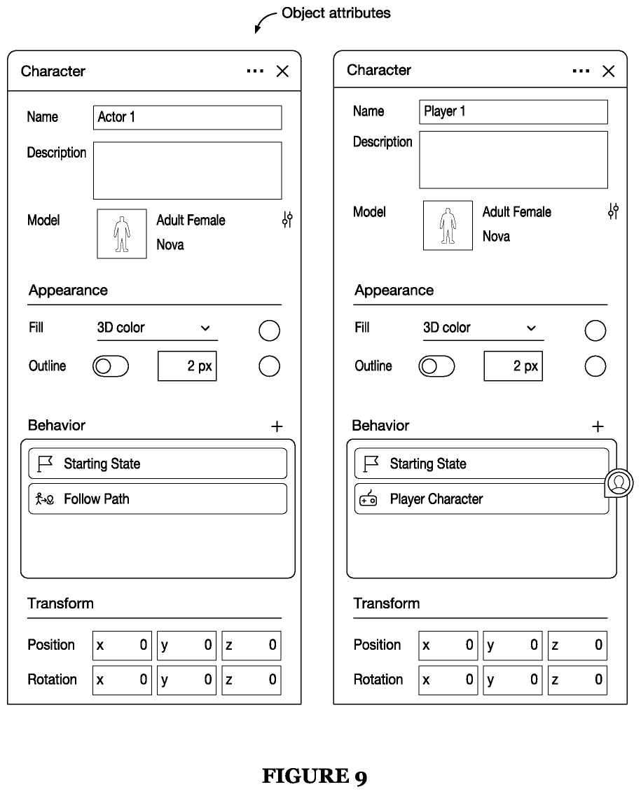

Determining a set of object attributes for each object instance functions to determine instructions on how to colorize the object's 3D model, define the mechanics of how the object's 3D model will interact with other object models within the scene, and/or perform other functionalities. Examples are shown in FIG. 9.

The set of object attributes can include object descriptions, visual settings, visual representations, and/or any other attributes. The object attributes can include natural language descriptions, images, LoRA matrices, object settings and descriptors, and/or any other suitable data. The object attribute values can be manually specified or automatically specified, and/or any other specification method. The set of object attributes associated with an object instance can be: a default set of object attributes inherited from the object type, an instance-specific set of object attributes received from a user or specified by the LLM, and/or any other set of object attributes. Object descriptions can include: storylines, object behaviors, object intelligence, and/or other object descriptions. In an example, the set of object attributes can include a user-written description of a character persona or backstory (e.g., object description) for each mobile object within the scene. In a specific example, a user can specify that the first instance of a Camry object type is a “red” Camry, a second instance of a Camry is a “camo wrapped Camry”, and a humanoid object type is a “gray alien”.

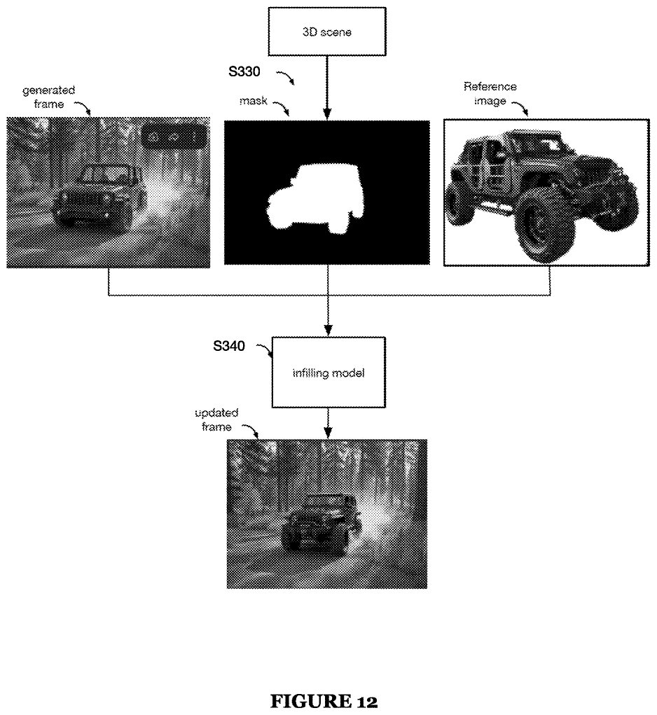

In variants, image and/or LoRA matrices can act as visual representations. Visual representations can act as visual references that define, through visuals, how an object is rendered in a frame. Visual representations can ensure that an object in a frame is rendered to match the visual representation. The visual representations that can be associated with an object model can include Low-Rank Adaptation (LoRA) matrices (e.g., a “LoRA”), image (e.g., reference image of one or more object views; example shown in FIG. 12), adapter layers, conditioning tokens, side network (e.g., ControlNet), and/or any other visual representation types.

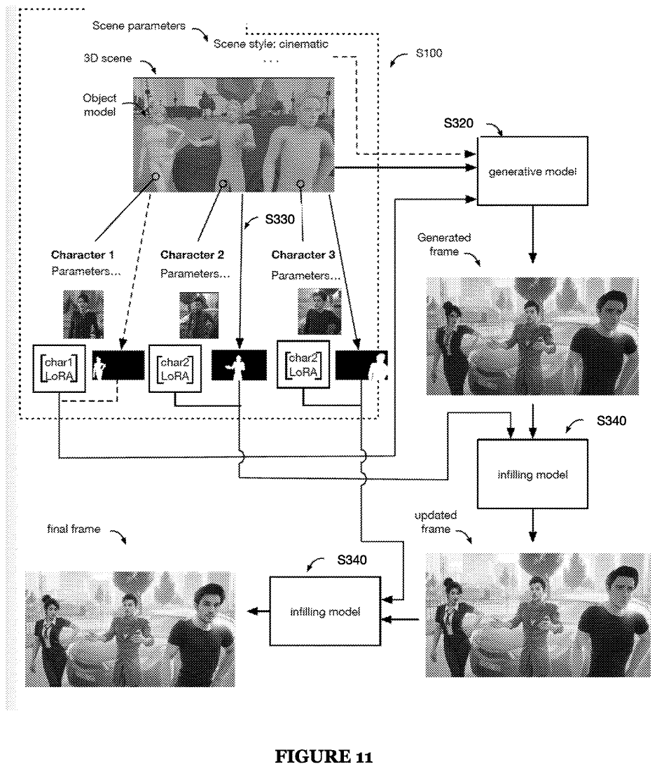

In variants, LoRAs are used to modulate into the rendering process to achieve consistent character likenesses across multiple passes. In variants, the LoRA matrices introduce a set of likeness-specific weights or weight adjustments (e.g., low-rank change, attention projections, etc.), which cause the model to render the character likeness. The LoRA is generated from training data that fine-tunes the model to render specific facial features, skin colors, and other character attributes. When applied to a character model during generation, the LoRA ensures that character-specific traits (e.g., Emily Clark's facial features or Data's pale skin) are consistently reproduced while maintaining the original pose, lighting, and scene context from the base render. A LoRA can be a rank decomposition matrix, a low rank matrix, or be otherwise constructed. Examples are shown in FIG. 10 and FIG. 11. Each LoRA matrix can be trained on the likeness of a given character or entity (e.g., a celebrity, a Disney character, a custom character, a Nike Air Jordan shoe, etc.), or trained on another task. The LoRA matrix can be learned by: inserting a trainable rank decomposition matrix alongside the model's original weight matrices, where the low-rank matrices capture the task-specific adaptations during fine tuning while the base model remains frozen, or otherwise learned. During training, only the LoRA matrices are updated through backpropagation, with the final adapted weights being computed as the sum of the original weight matrix and the product of the low-rank decomposition matrices scaled by a configurable factor. However, the LoRA matrix can be otherwise trained.

In operation, the LoRA is inserted alongside the base model's original model weights, wherein the LoRA matrix modulates the model rendering toward a character likeness. However, the LoRA matrix can be otherwise used.

However, determining a set of object attributes for each object instance may be otherwise performed.

However, the underlying 3D representation S100 may be otherwise defined.

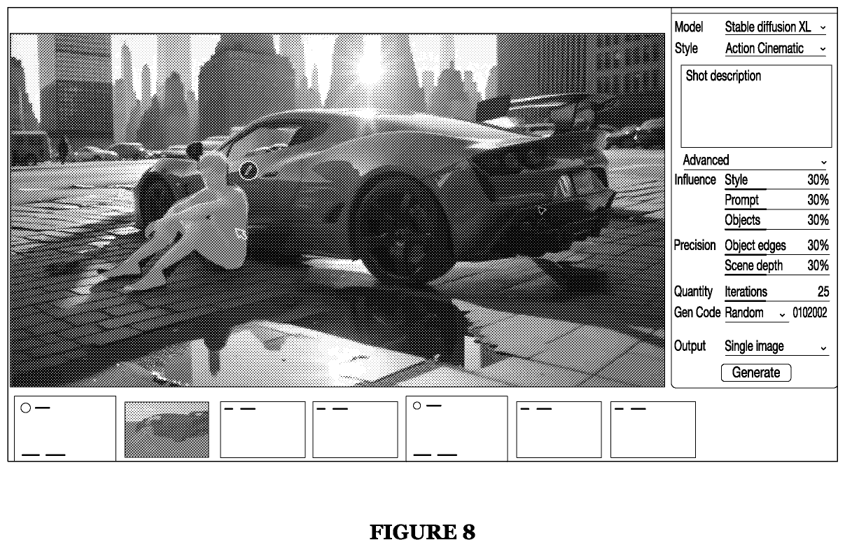

Defining visual media components S200 functions to specify how the storylines, and/or audio/video attributes of different frame sets should relate to each other across the visual media. All or portions of S200 can be repeatedly performed, performed once, and/or performed any number of times. The visual media can include: a film, sequences, shots, frames, animations, video, and/or other frame set. An example is shown in FIG. 8. The visual media can include one or more sequences, which function as a narrative unit of an overall visual media. The one or more sequences can be arranged in a series or otherwise organized. A sequence can be associated with one or more scenes, one or more visual settings, and/or other parameters. A sequence can include one or more shots, which can function as a continuous take (e.g., continuous, uninterrupted recording segment without any cuts or jumps in camera perspective). The one or more shots can be arranged in a series or be otherwise organized. Each shot is preferably associated with a single scene, but can alternatively be associated with multiple scenes. The shot can be associated with a continuous camera trajectory through the scene (e.g., the underlying 3D representation), and/or any other elements. The camera trajectory can be manually defined, predicted by a model (e.g., a trajectory model, an LLM based on a prompt describing a desired camera trajectory, etc.), and/or any other definition methods. A shot can include one or more frames. A frame can function to depict the visual appearance of the underlying 3D scene from the perspective of the camera at a single timepoint. The poses and relative relationships of the objects depicted in the frame can be defined by the underlying 3D representation, or be otherwise defined.

The visual appearance of each object depicted in each frame can be defined by the object attributes (e.g., object 3D models, object descriptions, etc.), visual settings (e.g., for the frame, for the object, etc.), and/or otherwise defined. The visual settings are preferably inherited from a parent element (e.g., shot, sequence, film, etc.), inherited from the scene or object, determined based on a storyline for the frame set (e.g., with automatically selected or generated values by an LLM based on the storyline), and/or otherwise determined. The frame preferably does not have a frame-specific visual setting (e.g., that deviates from the visual settings for other frames within the shot or other frame set), but can alternatively have a frame-specific visual setting. The frame can be generated frame by frame, generated as part of a block of frames (e.g., as a series of frames), and/or otherwise generated. A set of frames (frame set) can include a set of continuous frames (e.g., for contiguous timesteps), a set of keyframes (e.g., beginning, middle, end), and/or any other frames.

In variants, defining visual media components S200 includes defining a shot of the visual media S220; defining sequences of the visual media S240; and determining visual settings for one or more frame sets S260.

Defining a shot of the visual media S220 functions to define a continuous take within the visual media. S220 can be repeated one or more times to define different shots within a sequence or visual media.

In variants, S220 can include: determining the compositional structure of the scene (e.g., the 3D scene representation), receiving a camera trajectory through the scene, optionally sampling frames (e.g., instantaneous captures, keyframes, snapshots, etc.) of the 3D representation (e.g., series of uncolored 3D frames) along the camera trajectory, and optionally receiving a description for the shot (e.g., a storyline for the shot). An example is shown in FIG. 4.

Determining the compositional structure of the scene functions to define the organization of objects within the scene (e.g., relative poses, configurations, etc.). The compositional structure can be static or dynamic (e.g., vary over time). The compositional structure is preferably for a single scene, but can alternatively be for multiple scenes.

In a first variant, S220 can include treating the scene as static during the shot.

In a second variant, S220 can include animating each object within the scene according to a selected animation during the shot. The animations can be synchronized to a reference time, such as the beginning of the shot or sequence, and/or synchronized to any other suitable reference. The animations can play throughout the shot (e.g., generating a time series of 3D compositional scene structures, by changing the poses and configurations of the 3D models). The selected animation can be one of a set of predetermined animations associated with the object's type, be generated by a generative model (e.g., wherein the generative model is prompted, optionally with the 3D model or skeleton of the object, to provide an animation of the object), be animated by a user, be specified by a physics model, and/or any other animation method. The selected animation can be selected by a user, selected by an LLM (e.g., based on the story for the shot), randomly selected, generated by a generative model (e.g., based on the story for the shot, the object description for the object, etc.), and/or any other selection method.

In a third variant, S220 can include treating the scene as an initial scene for the shot, wherein the generative model animates the scene (e.g., without changing the poses of the 3D models).

However, determining the compositional structure of the scene can be otherwise performed.

Receiving a camera trajectory through the scene functions to define a set of scene perspectives throughout the shot. In a first variant, receiving the camera trajectory can include receiving a path through the scene from a user (e.g., drawn by the user). In a second variant, receiving the camera trajectory can include receiving a text prompt describing the desired camera trajectory, wherein a large model (e.g., LLM) defines the 3D path through the scene. In a third variant, receiving the camera trajectory can include receiving a selection of a predetermined path through the scene (e.g., “establishing shot”, “medium shot”, “close up”, “over-the-shoulder shot”, “action shot”, “reaction shot”, etc.). In a fourth variant, receiving the camera trajectory can include tracking the perspective of the scene as viewed through the interface as the user zooms in, out, left, and/or right within the scene (e.g., treating the user's perspective of the scene in the interface as the camera frame). However, the camera trajectory can be otherwise determined.

S220 can optionally include sampling frames (e.g., keyframes, instantaneous captures, captures, snapshots, etc.) of the 3D representation along the camera trajectory. This can be performed by projecting the 3D representation into the camera frame, ray tracing (e.g., from a virtual camera lens, and/or otherwise determining frames representative of the 3D representation. In variants, the sampled frames and/or captures can include instantaneous data related to the object 3D models (e.g., animation, position, scale, pose, etc.), the camera (e.g., camera position, camera trajectory, etc.), and/or any other suitable data. In these variants, the captures are time-specific captures of the 3D representation with a specified viewing direction, field of view, and/or viewing window. In other variants, the sampled frames and/or captures can be images and/or not include 3D information. For example, the sampled frames can be 2D images captured by virtual cameras. In another example, the sampled frames can include depth maps and/or other 3D information collected by the virtual cameras.

In an example, captures can be manually selected by a user. For example, a user can select specific timestamps and/or captures along a timeline of the 3D representation. In another example, sampling captures can include sampling captures of the 3D representation at a specified and/or predetermined sampling rate. In a third example, captures of the 3D representation can be adaptively sampled. For example, temporal segments of the 3D representation that have more motion may be sampled for captures at a higher rate. The captures can be generated according to any suitable sampling strategy, including user-defined, rule-based, model-driven, hybrid approaches, and/or any other approaches.

S220 can optionally include receiving a description of the shot (e.g., the storyline for the shot). The shot description can be used to inform the generative model of the higher-level storyline when generating individual frames in the shot. The shot description can be received from a user, inherited from the sequence, automatically determined (e.g., by an LLM, etc.), and/or otherwise determined.

However, defining a shot of the visual media S220 may be otherwise performed.

Defining sequences of the visual media S240 functions to define sequences of shots. S240 can include ordering one or more shots into a sequence, receiving a description of the sequence (e.g., the storyline for the sequence, used to inform the generative model when generating frames of the sequence, etc.), and/or otherwise defined. However, defining sequences of the visual media S240 may be otherwise performed.

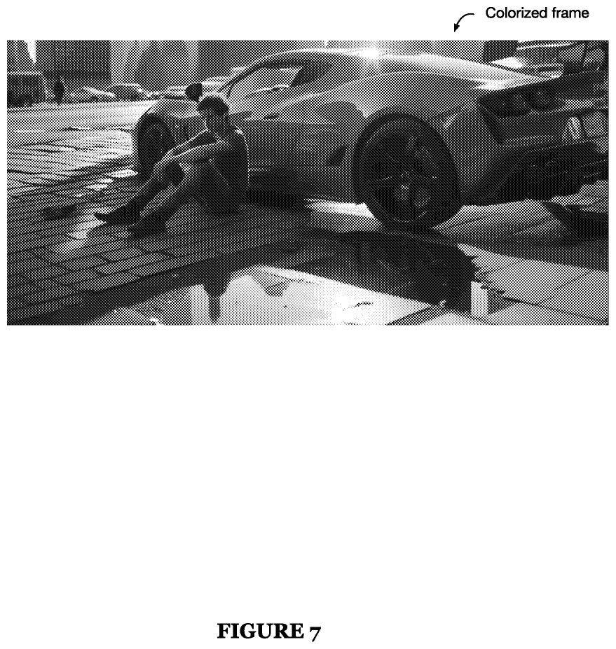

Determining visual settings for one or more frame sets S260 functions to specify constraints on the generative model's visual generation, and can function to provide visual consistency across frames (e.g., within a shot, within a sequence, etc.). Examples are shown in FIG. 4, FIG. 5, FIG. 6, and FIG. 7.

The visual settings can instruct how the generative model should render the asset (e.g., frame, audio, video, etc.). The visual settings can be: a set of prompts, set of selectable values (e.g., used to fill prompt templates, used to set hyperparameters for the generation run, etc.), and/or be otherwise configured. The visual settings can include: visual style, generative model settings, light responses, and/or other settings.

Visual style functions to define the aesthetic and rendering characteristics for the resultant frames. Examples of visual styles that can be selected include: “noir”, “animation”, “action cinematic”, and/or other styles. Each individual style can be associated with an expanded description (e.g., style prompt) that describes different aspects of the style. In variants, the expanded description can be sent to the generative model when generating the frames in lieu of or in addition to the style name, or otherwise used.

The generative model settings can include diffusion settings, temperature, latent space settings, model architecture settings, conditioning strength, consistency settings, and/or other settings. The diffusion settings can include: the number of sampling steps, guidance scale, noise schedule, latent resolution, and/or other settings.

The light responses can include light diffusion, subsurface scattering, diffusion strength, and/or any other visual settings.

In variants, the visual settings can be associated with a unique visual setting identifier (e.g., name, icon, dropdown, randomly generated number, hash of the visual setting values, etc.), wherein the visual setting can be applied to individual elements when the visual setting identifier is associated with the individual element (e.g., selected for the element, dragged-and-dropped onto the element, etc.).

The visual settings can be manually determined, learned, extracted from example frames (e.g., from another shot or scene), inherited (e.g., from a parent element or child element), and/or otherwise determined. In an example, the visual settings can be inherited from parent elements (e.g., parent sequences, parent shots, scenes, etc.), inherited from child elements (e.g., child shots, child frames, individual objects within a scene, etc.), or otherwise determined. The visual settings of child elements preferably override the visual settings of parent elements (e.g., the parent element's visual settings can be used as the default for the child elements); alternatively the visual settings of the parent elements can override the visual settings of the child elements.

Each scene component and frame set is preferably associated with its own set of visual settings, but can alternatively not have its own set of visual settings. In a first example, individual frames preferably do not have frame-specific visual settings. In a second example, a contiguous block of frames can be associated with a block-specific set of visual settings. In a third example, the scene can have a set of scene visual settings, each object can have a set of object visual settings, the visual media can have an overall set of visual media visual settings, each sequence can have a set of sequence visual settings, and each shot can have a set of shot visual settings. In a first specific example, the visual settings for parent elements can be used as default values, while the specifically-defined visual settings for child elements can override the visual settings for parent elements (e.g., object visual settings can override all other visual settings, shot visual settings override sequence visual settings and visual media visual settings, etc.). In a second specific example, different visual settings for element hierarchies are combined (e.g., by averaging, using a weighted sum, etc.), and/or any other handling method.

In a first variant, S260 can include receiving values for the visual settings from a user. The user can select the visual settings from a predetermined set of visual settings, write a description for the visual settings, select values for different visual setting parameters, and/or otherwise determine the visual settings. In an example, the user can drag and drop an icon, representative of a predetermined set of visual settings, onto a shot or sequence, wherein the predetermined set of visual settings are automatically applied to the shot or sequence.

In a second variant, S260 can include selecting an example frame from another frame set (e.g., another shot, another sequence, etc.), wherein the generative model is instructed to generate additional frames similar to the example frame in appearance. The example frame can alternatively be otherwise used.

In a third variant, S260 can include inheriting the visual settings from a parent or child element. In an example, a shot can inherit visual settings from a sequence (e.g., when the shot's visual settings are unspecified, etc.). In another example, an object can inherit visual settings from the scene (e.g., when the object's visual settings are unspecified, etc.).

However, determining visual settings for one or more frame sets S260 may be otherwise performed.

However, defining visual media components S200 may be otherwise performed.

Generating a set of frames for the visual media S300 functions to generate one or more frame sets. Examples are shown in FIG. 4 and FIG. 5. The frame sets can be shots, sequences, keyframes, and/or other frame sets. In an example, S300 can generate a set of keyframes for the visual media or frame set (e.g., frame for every 10th second, a beginning, middle, and endframe, etc.) using a set of generative models. In variants, keyframes are passed to a secondary model (e.g., MidJourney™, CGI model, gaming engine, etc.) that generates the frame set based on the keyframes (e.g., by interpolating between the frames, etc.). In an example, keyframes sampled in S220 can be used to generate the set of frames. For example, keyframes of the 3D representation sampled in S220 can be rendered to generate a set of frames. In variants, a frame can be represented as a 2D representation, an image (e.g., PNG format, JPEG format, etc.), a holographic image, a stereoscopic image, a depth image, tensor representation, and/or any other structured or encoded representation of visual or scene information.

S300 can be repeated one or more times to generate one or more shots, one or more sequences, one or more versions of the visual media, one or more versions of the frame set, and/or any other frame sets. For example, S300 can be repeated to regenerate frame sets with different scene composition, different object attributes (e.g., animation, timing, storylines, descriptions, object types, etc.), different visual settings (e.g., different style, different diffusion settings, etc.), and/or other changed parameters, while maintaining the values for unchanged parameters. S300 preferably includes generating multiple frames at the same time, but can alternatively include generating frames individually.

S300 is preferably performed by one or more rendering models (e.g., frame generation models, object-specific models, etc.). Different frames and/or different portions of each frame can be rendered by the same or different rendering model. In variants, the system can include a plurality of rendering models, where each model can be tuned, trained, optimized and/or otherwise configured to render different objects, render different visual styles, and/or perform any other different renderings. The system can additionally include models for general rendering and/or entire scene rendering. Rendering models can be tuned and/or optimized based on objects, object type, object metadata, object style parameters, rendering style, cinematic style, and/or any other properties. Examples of object types and/or subtypes can include humans (e.g., adults, children, babies, etc.), vehicles (e.g., trucks, cars, motorcycles, planes, etc.), plants (e.g., trees, bushes, flowers, etc.), environment assets (e.g., buildings, walls, etc.), furniture (e.g., tables, chairs, etc.), objects (e.g., cups, phones, pots, electronic devices, etc.), animals (e.g., dogs, cats, fish, farm animals, etc.), and/or any other suitable object type. The set of rendering models can include object specific models. Examples of object specific models include but are not limited to, human-specific models, clothing specific models, vehicle-specific models, architectural models (e.g., for buildings, entryways, walls, floors, ceilings, roads, walkways, etc.), animal-specific models, plant-specific models, inanimate object models, animant object models, mineral models (e.g., for earth, dirt, soil, ground, rocks, sediments, etc.), fluid models (e.g., for water or other liquids), plant models (e.g., grasses, trees, bushes, shrubs, etc.), weather models (e.g., for wind, clouds, etc.). In some variants, only a subset of generative models of the set of generative models are used (e.g., only generative models associated with an object within the frame).

In a specific example, the system can include a rendering model configured (e.g., trained, tuned, optimized, etc.) to render humans, a rendering model configured (e.g., trained, tuned, optimized, etc.) to render cars and/or other automotive vehicles, a rendering model trained (e.g., trained, tuned, optimized, etc.) to render plants, a rendering model configured (e.g., trained, tuned, optimized, etc.) to render animals, and/or any other suitable models.

In variants, a rendering model can be selected for a specific portion of a frame based on an object represented in that specific portion of the frame. For example, the objects present within a frame and/or keyframe can be determined (e.g., based on the 3D representation, based on metadata, etc.). Based on the determined objects, a set of models can be selected (e.g., according to the object types, object visual references, object metadata, object style parameters, etc.) and each model can be utilized to render a corresponding portion of the frame and/or keyframe, resulting in a fully generated frame. The model can render the portions sequentially, in parallel, and/or in any suitable manner. Utilizing a set of rendering models can have the benefit of improved rendering fidelity and specialization. For example, models trained or optimized for particular object classes (e.g., humans, vehicles, plants, animals) can capture class-specific visual features, textures, geometries, and motion patterns more accurately than a general-purpose rendering model. This specialization can result in higher visual realism, more consistent object appearance across frames, and/or improved rendering of complex or highly variable object types.

The rendering model(s) are preferably a generative AI model (e.g., diffusion model, transformer, text to video model, image to video model, text to image model, etc.), but can alternatively be a CGI or 3D animation renderer (e.g., use ray tracing, rasterization, path tracing, global illumination, etc.), real-time game engines (e.g., unreal engine(tm)), post-processing renderers, and/or any other rendering model. The rendering model used to generate frame sets can be automatically determined (e.g., based on the underlying 3D representation, visual settings, complexity, etc.), manually selected, and/or otherwise determined.

Portions (e.g., segments, pixels, etc.) of the resultant frames can be associated with (e.g., correspond to) an object model in the underlying 3D representation. Individual portions of a frame (e.g., the segment of the frame corresponding to a selected object instance) can be dynamically regenerated and stitched back into the rest of the frame. An example is shown in FIG. 8. In variants, the frame can include metadata associated with the objects and/or 3D models (e.g., object identifiers) rendered in the frame. This metadata can be consistent across all frames of a scene and/or vary across frames. In a variant, every pixel of a frame can be associated with an object identifier.

The frame set can be generated based on: the 3D representation, the object attributes for all or some of the objects in the 3D representation, the visual settings for the set of frames, the description for the set of frames (e.g., the storyline for the frame set), virtual camera data, a set of keyframes (e.g., determined in S220, etc.), natural language inputs and/or prompts, and/or any other set of inputs. Examples are shown in FIG. 4 and FIG. 5.

In variants, the set of inputs can optionally include weights for different inputs (e.g., example shown in FIG. 8), wherein the generative model can use the weights as constraints when generating the frame. In a first example, the visual style, prompt, and object attributes can be given different weights, where the generative model can bias toward using the visual attributes of the higher-weighted setting when generating the frame. In a second example, weights for the object edges and scene depth can define how far the generative model can deviate from the object edges and/or predefined scene depth regions.

In a first variant, S300 can include: generating a series of un-colorized frames from the underlying 3D representation (e.g., scene); determining the object attribute set for each object depicted in each un-colorized frames; determining visual settings for the series of un-colorized frames (e.g., the shot visual settings, the sequence visual settings, the combined visual settings, different settings for different portions of each un-colorized frame, etc.); individually generating an individual colorized frame for each un-colorized frame based on the respective un-colorized frame, the associated object attribute sets, and the visual settings using a generative model (e.g., diffusion model); and stitching the individual colorized frames together into a series of colorized frames (e.g., a shot, a sequence, etc.). An example is shown in FIG. 4. The series of un-colorized frames from the underlying 3D representation (e.g., scene) can be generated by animating the objects within the scene (e.g., by specifying an animation, selecting timing relative to the shot, etc.), by sampling portions of the scene visible within the camera's field of view (e.g., by projecting the 3D representation into the camera plane) at different points along the camera's trajectory, and/or otherwise generated. Generating an individual colorized frame based on the respective un-colorized frame, the associated object attribute sets, and the visual settings can include: prompting a generative model to generate a colorized frame using the un-colorized frame, the associated object attribute sets, and the visual settings; setting the hyperparameters for the generative AI model based on the visual settings; and prompting the generative AI model with the un-colorized frame and the associated object attribute sets. However, the colorized frames can be otherwise generated. An example is shown in FIG. 7. The un-colorized frame can be passed to the generative AI model as a flat image (e.g., depicting object boundaries or object masks), be passed to the generative AI model as a 3D model (e.g., mesh format, point cloud format, etc.), a set of text descriptors (e.g., in a table, etc.), and/or passed to the generative AI model in any other suitable format. In an example, the generative AI model can be instructed to treat the object boundaries depicted in the un-colorized frame as hard constraints, wherein the generative AI model can only colorize the region within a given object boundary based on the object attribute set for the corresponding boundary and the visual settings for the set of frames. Alternatively, the object boundaries can be treated as soft constraints, references, and/or otherwise treated by the generative model.

In a second variant, S300 can include passing the 3D scene representation, the object attribute set for each object within the scene, the visual settings for the frame set, the animation descriptions for each object and/or the storyline for the frame set to the generative model, wherein the generative model generates a video (e.g., series of frames) using the 3D scene representation as a starting point or constraint.

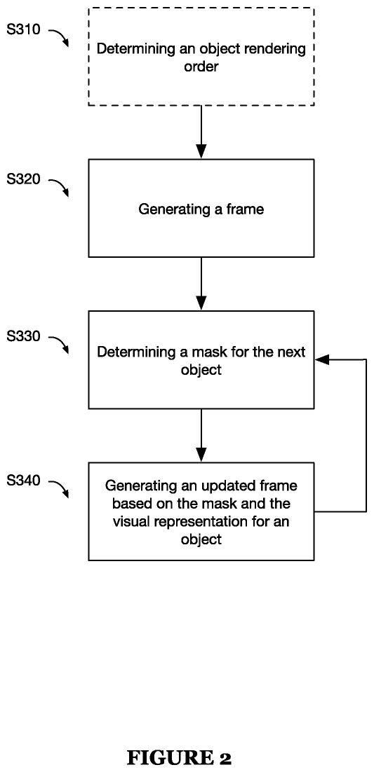

In variants, S300 can include processing of specific objects and/or characters within a frame. As shown in FIG. 2, S300 can include optionally determining an object rendering order S310; generating an initial frame S320; determining a mask for an object S330; and generating an updated frame based on the mask and the visual representation for an object S340. This process functions to generate frames with multiple photorealistic characters while preserving their specific identities.

Processing of specific objects and/or characters of a frame can optionally include determining an object rendering order S310, which functions to prevent objects from being obscured or rendered over. S310 can also reduce rendering time and rendering passes by identifying low visibility or fully obstructed objects that do not need to be rendered. S310 can be limited to objects with visual representations or limited to objects with visual representations of a certain type (e.g., only objects associated with LoRAs), but alternatively can be applied to all objects within the scene construct, a subset set of objects, and/or any other suitable set of objects from the scene construct. S310 can be performed after generating the masks for each object S330, performed before S330, or performed at any other time.

The object rendering order can be determined based on a set of heuristics, by prompting a model (e.g., transformer, large model, DNN, etc.) to provide a rendering order based on the scene construct, manually determined, predetermined, and/or any other suitable method.

In a first variant, determining an object rendering order S310 can include projecting each object model into the frame (e.g., performing S330 or projecting the object model independently of S330), determining the amount of overlap between the object projections, and ordering objects according to a heuristic or ruleset. The heuristic or ruleset can include: ordering the objects from least to most overlapped (e.g., % overlap, number of pixel overlapped, etc.), ordering the objects based on depth (e.g., closest to furthest from the virtual camera), ordering the objects based on visibility (e.g., from highest % visible to lowest % visible; from highest number of pixels visible to lowest number of pixels visible), ordering the objects based on frame occupancy (e.g., from highest % of frame occupancy to lowest, etc.), and/or any other suitable heuristic. In an example, when the scene includes a character in a car, the character is rendered after the car is rendered to ensure that the character remains visible through the car windows; otherwise, the character will be painted over by the car's LoRa.

In a second variant, determining an object rendering order can include removing objects from the rendering list, where the rendering list initially includes all objects within the 3D scene. Objects can be removed from the rendering list by projecting the object geometry into the frame and removing objects with object projections that satisfy a set of removal conditions, or otherwise removed. The set of removal conditions can include the object projection occupying less than a threshold proportion of the frame (e.g., less than 10%, 5%, 2%, 1%, etc. of the frame), the object projection being null (e.g., the object would be visually obstructed), and/or any other removal condition.

In variants, the objects can be rendered at once, sequentially, and/or in any other manner. For example, all visual representations for all 3D models can be passed to the frame generation model together. In another example, each set of visual representations for each 3D model can be passed one-by-one. In examples, in which all visual representations are together, the frame generation model may render them sequentially based on a model-determined object rendering order.

However, determining an object rendering order S310 may be otherwise performed.

Generating a frame S320 functions to generate an initial visual frame. The frame can be an image (e.g., RGB image), a video frame, a 2.5D image (e.g., RGB image with depth encoded into a channel), and/or any other frame. S320 is preferably performed using a generative model, but can alternatively be performed using a CNN, another neural network, and/or another method. Examples of generative models that can be used include: diffusion models, generative adversarial networks (GANs), variational autoencoders (VAEs), autoregressive models, transformer-based architectures, flow-based generative models, and/or any other generative models.

The frame is preferably generated based on scene construct, but can be generated based on any other input. The frame is preferably generated using the visual representation for a single object (e.g., examples shown in FIG. 10 and FIG. 11), but can alternatively be performed using the visual representation for the ranked objects, a subset of objects from the scene construct, all objects from the scene construct, and/or any other suitable visual representation.

The frame is preferably generated using a generative model (e.g., diffusion model, etc.) to generate (e.g., predict) a frame, but can alternatively be generated using a CNN, DNN, and/or any other model. The generative model can be: prompted to generate the frame, run with the inputs to generate the frame, and/or otherwise used to generate the frame.

The inputs to the generative model can include: a representation of the 3D scene (e.g., a graph representation, a set of object model masks projected into the virtual camera plane, the 3D scene itself, etc.); virtual camera capture data, object parameter values for objects within the scene; a visual representation of an object in the 3D scene (e.g., a LoRA for an object); an optional prompt; and/or other inputs. The visual representation that is passed to the generative model is preferably the visual representation for the first object in the object rendering order, but can alternatively be for the next-unrendered object in the object rendering order, a randomly selected object, and/or for any other suitable object. In variants, the pre-generated masks for one or more objects (e.g., for the first object, all objects, etc.) can optionally be passed to the generative model, where the generative model can be instructed to render the respective object appearances within the space indicated by the respective mask. However, no masks can be passed, or the masks can be otherwise used.

The resultant generated frame can include the object's likeness rendered in the object's frame segment (e.g., masked region), and can include hallucinated likenesses, the object likeness, and/or other appearances for the remaining objects. However, the generated frame can be otherwise constructed.

However, generating a frame S320 may be otherwise performed.

Determining a mask for an object S330 functions to determine the pixels in the generated frame that should be re-rendered using the next object's visual representation (e.g., the next object's LoRA). S330 can be performed after each frame is generated (e.g., iteratively performed with S320), but alternatively can be performed before or independent of frame generation (e.g., example shown in FIG. 10). S330 can be performed based on a generated frame, be generated independent of the generated frame (e.g., based on only the scene construct and the virtual camera field of view), or be otherwise generated. The next object is preferably the next, unrendered object in the object rendering order, but can alternatively be a randomly selected object, manually selected object (e.g., wherein the user selects the object by selecting a region corresponding to the object on the generated frame), any object associated with a visual representation, and/or be any other suitable object. The resultant mask is preferably pixel-accurate (e.g., exactly masks out all pixels belonging to the object segment depicted in the frame), but can alternatively be slightly dilated (e.g., larger than the frame segment corresponding to the object), slightly undersized, slightly inaccurate (e.g., by less than a threshold number or % of pixels), or otherwise sized.

In variants, determining a mask for an object S330 includes determining an object segment for the next object S332; and optionally modifying the object segment S334. The object segment can be a segment of the frame depicting the object, and/or any other representation of the object pixels within the frame. In variants, each pixel of an object segment can be associated with the same object identifier. However, an object segment can be otherwise characterized.

In a first variant, determining an object segment for the next object S332 can include projecting the object model for the object from the 3D scene into the virtual camera plane or into the generated frame. In the latter variant, this projection is possible because the frame is generated from and aligned with the 3D scene, such that a projection of the object model from the 3D scene into the frame's plane segments out the object pixels. In another variant, depth maps, normal maps, scene and/or object maps, object properties, specular data, depth filters, and/or any other data can be used to determine an object segment.

In a second variant, the object segment can be determined by passing the generated frame through an image segmentation model (e.g., a CNN, autoencoders, encoder-decoder, FCN, DNN, etc.).

In a third variant, an object segment can be determined based on a natural language prompt. For example, a user can provide input specifying performing a modification to the “left-most man in the frame”. In another example, a user can provide input for re-rendering “the front section of the car”. A language model associated with the mask generator module can process the natural language input and determine an object segment based on the prompt.

However, determining an object segment for the next object S420 may be otherwise performed.

Modifying the object segment S334 can include dilating, shrinking, offsetting, and/or otherwise modifying the object segment. The modification amount (e.g., dilation amount) for S334 can be: predetermined (e.g., 5% isotropic dilation, etc.); manually determined; dynamically determined (e.g., based on the object type, the object's depth in the 3D scene, etc.); and/or otherwise determined.

However, modifying the object segment S334 may be otherwise performed.

However, determining a mask for an object S330 may be otherwise performed.

Generating an updated frame based on the mask and the visual representation for an object S340 functions to render the next object (e.g., character) in the frame. In variants, S340 can ensure object visual consistency and identity by isolating each generation pass to a single object. S340 is preferably performed for a single object each iteration, but can alternatively be performed for multiple objects each iteration. S340 is preferably performed for the next object in the rendering order, but can alternatively be performed for a randomly-selected object, manually selected object, a previously-rendered object, and/or any other object from the scene construct. S340 can be repeated for each object associated with a visual representation in the scene construct, repeated when a new visual representation is received for an object in the scene construct (e.g., example shown in FIG. 12), and/or otherwise repeated. In variants, S340 can be iteratively repeated for the next object in the object rendering order until all objects are rendered (e.g., to sequentially render each character in the frame). In variants, this can optionally include repeating S330 for the next object during each iteration. Alternatively, the mask for the next object can be predetermined and retrieved, or otherwise determined. Each portion of a frame can be rendered based on object rendering parameters.

In variants, the object rendering parameters, object rendering references, and/or visual representations associated with each object model can include any referenceable asset that defines, constrains, or influences how the object is rendered by a generative model. Examples include, but are not limited to: reference images (e.g., one or more static images depicting the object from one or more viewpoints); video sequences (e.g., one or more video clips depicting the object, capturing motion characteristics, temporal appearance, dynamic visual attributes, etc.); low-rank adaptation (LoRA) matrices (e.g., trained to bias a generative model toward producing outputs resembling the object); (fine-tuned) generative models (e.g., trained on image data, video data, other training data depicting the object, etc.); latent feature vectors (e.g., identity embeddings, CLIP embeddings, IP-Adapter embeddings) determined by processing image data and/or video data of the object through an embedding model; adapter weights insertable into the generative model (e.g., ControlNet weights, IP-Adapter weights, T2I-Adapter weights, etc.); structured metadata describing visual attributes of the object (e.g., natural language descriptions, attribute tags, material properties, color specifications, etc.); conditioning tokens or token sequences derived therefrom; combinations thereof; and/or other suitable parameters. Each object model can be associated with one or more rendering references of the same or different types, and different object models within the same scene can be associated with rendering references of different types.

In a first example, S340 is performed for the next-unrendered object in the object rendering order, after the prior object is rendered into the frame. In a second example, S340 is performed when a new reference image or LoRA is received for an object in the scene construct to update or change the visual appearance of the object in the frame. In an illustrative example, a Taylor Swift LoRA can be received for an object in the scene construct that was previously associated with a Captain Hook LoRA, wherein S500 is repeated using the Taylor Swift LoRA and the object mask to infill the Captain Hook region with a Taylor Swift appearance.

S340 can be performed using an infilling model, but alternatively can be performed using another model. The infilling model can be a diffusion model, a masked autoencoder, a CNN-based inpainting model, a GAN model trained for image completion, etc.), and/or have any other suitable architecture. The infilling model can: infill, inpaint, render a de novo frame, render a de novo object segment (e.g., frame segment), and/or otherwise generate the updated frame. The infilling model is preferably different from the generative model used in S320, but can alternatively be the same model. In examples, infilling models that can be used include: Stable Diffusion Inpainting, Flux, and/or any other infilling models. The infilling model can regenerate the entire frame, generate a segment of the frame (e.g., the object segment of the frame), or regenerate any suitable segment of the frame. The infilling model can be strictly constrained to rendering within the boundaries of the mask (e.g., determined in S330), or be allowed to deviate from the boundaries (e.g., infill a smaller region or a larger region than the mask).

In a first variant, S340 can include using an infilling model to infill the masked region of the generated frame, based on the visual representation for the next object (e.g., a LoRA for the next object). The infilling model can be prompted to generate the frame, run with the inputs to generate the frame, and/or otherwise used to generate the frame. The inputs to the infilling model preferably include the generated frame, the visual representation, and the mask, but can additionally or alternatively include: the 3D scene, object descriptions, scene parameters (e.g., style, etc.), and/or other inputs. In variants, the infilling model can use the generated frame as context for generating the updated frame (e.g., to provide or preserve lighting context, stylistic context, etc.). The resultant generated frame can include the object's likeness rendered in the object's frame segment (e.g., masked region), the likenesses of previously-rendered objects rendered in the previously-rendered objects' frame segments, and can include hallucinated likenesses, the object likeness, and/or other appearances for the remaining objects. However, the resultant updated frame can be otherwise constructed.

In a second variant, S340 can include using the infilling model to generate the object segment for the next object (e.g., generate the appearance for the masked segment), wherein the resultant frame segment can be composited with the prior generated frame to generate the updated frame. The infilling model can be provided with the generated frame (e.g., for context), the next object's mask, the next object's visual representation, and/or other inputs.

However, generating an updated frame based on the mask and the visual representation for an object S340 may be otherwise performed.

However, generating a set of frames for the visual media S300 may be otherwise performed.

Generating a video based on the set of frames S400 functions to utilize the set of frames to create a continuous and visually consistent video. For example, S400 can function to generate intermediate frames between keyframes to produce a continuous video. S400 can be performed after S300, after S200, after S100, or at any other time with respect to the other steps. S400 can be performed in-response to generating a set of frames, after generating a threshold number of frames, intermittently, periodically, and/or at any suitable frequency. S400 can be performed using a video generation model.

The video generation model can include a machine learning model (e.g., neural network, convolutional neural network, recurrent neural network, deep neural network, transformer, generative adversarial networks, hybrid architectures, and/or any other suitable model. The video generation model preferably receives, as input, a set of frames (e.g., frames generated in S300), but can additionally and/or alternatively receive as input the underlying 3D representation, 3D models, visual representations, metadata, and/or any other suitable data. The video generation model can produce a video file (e.g., MP4, MOV, AVI, MKV, WMV, FLV, WebM, MPEG, etc.), a holographic video, a volumetric video, a stereoscopic video, a frame sequence, and/or any other output.

The video generation model can interpolate frames between keyframes (i.e., intermediate frames between two temporally adjacent keyframes), refine temporal transitions, enforce motion consistency across consecutive frames, adjust visual attributes (e.g., lighting, texture continuity, camera motion, depth-of-field effects, color grading, and object persistence), and/or perform any suitable task to generate a temporally coherent video sequence. The video generation model can additionally perform temporal smoothing, motion compensation, artifact reduction, resolution upscaling, frame rate conversion, scene blending, compression-aware optimization, and/or any other processing step. In some variants, the video generation model can condition generation on metadata (e.g., timestamps, camera trajectories, scene parameters, user constraints) to maintain consistency with the underlying 3D representation and/or intended shot characteristics.

For example, the video generation model can interpolate intermediate frames between adjacent keyframes by estimating optical flow, latent motion vectors, and/or feature correspondences between frames, and generating intermediate pixel values consistent with estimated motion trajectories. In another example, the video generation model can enforce temporal consistency by propagating latent feature representations across frames using recurrent layers, attention mechanisms, transformer-based architectures, and/or any other architecture that models long-range temporal dependencies. In another example, the video generation model can perform frame refinement by applying a post-processing network configured to reduce flicker, correct geometric distortions, harmonize lighting variations, enhance perceptual quality across the video sequence, and/or any other processing steps.

In some variants, the video generation model can perform optical flow-based interpolation, phase-based interpolation, trajectory-based interpolation, and/or any other processes, algorithms, and operations. For example, the video generation model can determine forward and backward optical flow fields between adjacent keyframes, and compute intermediate pixel locations by interpolating motion vectors proportionally to a target timestamp. The model can then resample pixel values using the interpolated flow fields and blend forward-and backward-warped frames to generate an intermediate frame. In another example, the video generation model can decompose frames into multi-scale, multi-orientation frequency bands (e.g., using a steerable pyramid), estimate phase differences between corresponding bands of adjacent frames, and interpolate intermediate phase values as a function of time. The interpolated phases can then be reconstructed into an intermediate image, where smooth phase transitions correspond to smooth motion. In a third example, the video generation model can estimate object keypoints or bounding boxes across keyframes, fit spline curves (e.g., cubic splines or Bézier curves) to object trajectories, and render intermediate object positions at intermediate timestamps. The rendered object positions can then be composited into a frame while preserving geometric and kinematic consistency.

In a variant in which the video generation model is a diffusion model, the model can generate video data through a staged refinement process based on a forward noising procedure and a learned reverse process. For example, during training, structured data (e.g., frames and/or sequences of frames) can be progressively perturbed by adding random noise over a series of timesteps. The model is trained to predict how to reverse this corruption at each timestep. During generation, the model can begin from a noise distribution and iteratively apply the learned reverse process to produce structured video content. This iterative process can gradually transform an unstructured signal into a coherent frame sequence. The diffusion process can operate in pixel space and/or in a latent space, and can incorporate conditioning information (e.g., keyframes, motion parameters, camera trajectories, semantic constraints, etc.) at each timestep to guide the generation toward a desired temporal and spatial structure.

In a variation in which the video generation model utilizes an underlying 3D representation, the model can condition frame generation on geometric, structural, and/or semantic information derived from the 3D representation to ensure consistency with the spatial configuration of the scene. Consistency can include geometric consistency (e.g., stable object shapes, preserved spatial relationships, correct occlusions), viewpoint consistency (e.g., alignment with camera pose and viewing direction), photometric consistency (e.g., lighting direction, shading, and reflectance properties consistent with the 3D scene), and temporal consistency (e.g., persistent object identities across frames).

For example, the video generation model can project 3D geometry onto a 2D image plane using camera parameters associated with each frame and use the resulting depth maps, normal maps, segmentation masks, and/or rendered features as conditioning inputs during generation of intermediate frames. In another example, the model can constrain intermediate frame synthesis such that object positions and orientations correspond to their 3D coordinates, thereby reducing drift, deformation artifacts, and/or inconsistencies in scale or perspective across the video sequence.

In another example, the 3D representation can be used as a reference for re-generating intermediate frames. For example, if there are visual inconsistencies between intermediate frames and the 3D representation, an intermediate frame can be regenerated. Example of inconsistencies can include geometric inconsistencies (e.g., deformation inconsistent with 3D models, incorrect scale, misaligned position relative to 3D coordinates, or depth ordering errors), occlusion inconsistencies (e.g., missing or spurious occlusions relative to depth maps), viewpoint inconsistencies (e.g., parallax or perspective misalignment with a defined camera trajectory), photometric inconsistencies (e.g., lighting direction, shading, or shadow placement inconsistent with defined light sources and surface normals), texture inconsistencies (e.g., UV misalignment or material drift), temporal inconsistencies (e.g., jitter, motion trajectory deviations, or object identity drift), and/or any other consistency. If an intermediate frame is determined to be inconsistent, the video generation model can re-generate the intermediate frame. In variants inconsistencies can be quantified using using IoU, pixel-wise metrics, mean squared error, root mean squared error, mean absolute error, peak signal-to-noise ratio, structural similarity, learned feature-based metrics, optical flow and/or motion consistency metrics, and/or any other metric.

Following generation of the intermediate and/or regenerated frames, the frames can be post-processed and assembled into a continuous video sequence. Post-processing can include ordering the frames according to a temporal index, concatenating the frames into a video stream, encoding the stream into a selected video container format, and/or any other steps. In some variations, the post-processing stage can further include temporal smoothing (e.g., reducing frame-to-frame jitter or flicker), motion stabilization, color normalization, exposure harmonization, applying film visual effects and/or settings (e.g., determined in S100 and/or S200, etc.), spatial filtering to reduce artifacts introduced during interpolation or regeneration, and/or any other processes. For example, a temporal filtering operation can be applied across adjacent frames to smooth intensity fluctuations while preserving motion boundaries, and a stabilization operation can adjust frame alignment to reduce unintended camera drift. The processed frames can then be encoded using a selected codec and packaged into a finalized video file for storage, transmission, playback, and/or any other use.

However, S400 can be otherwise performed.

### 4. System

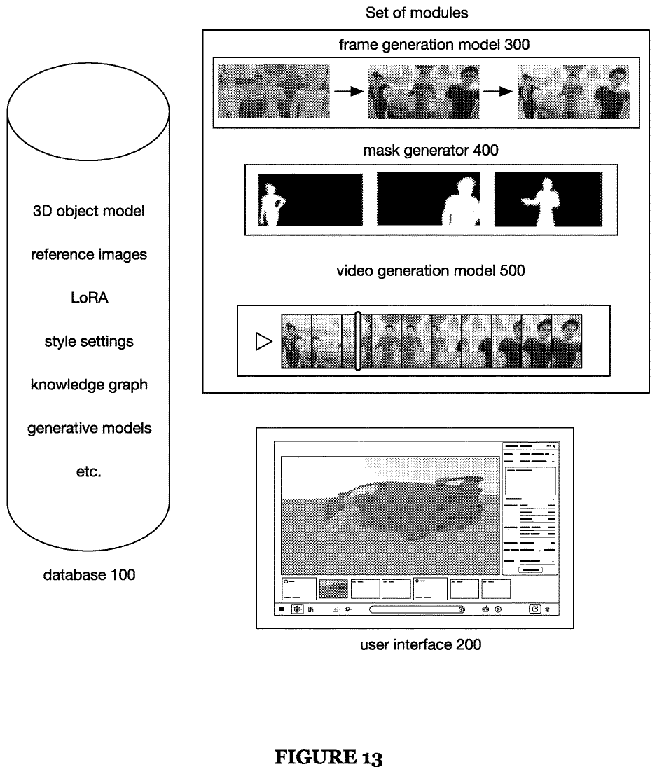

In variants, the system can include a database 100; a user interface 200; and a set of modules. The set of modules can include a frame generation model 300, a mask generator 400, a video generation model 500, and/or any other modules, as shown for example in FIG. 13. The system functions to produce frames, shots, scenes, sequences, films, and/or videos. In variants, the modules can be integrated together (e.g., to create an end-to-end workflow), disjointed, arranged sequentially, arranged hierarchically, and/or otherwise organized. For example, the modules can produce frames, modify frames, and generate video in a continuous process. In other examples, the process can involve user involvement across various steps.

In variants, the system can produce video sequences that are temporally consistent across frames (and/or between frames acquired with the same timestamp for stereoscopic image sets) and structurally consistent with an underlying 3D representation and/or scene. In variants, by utilizing the 3D representation and/or scene as a governing data structure, the video generation model can constrain frame synthesis according to object geometry, spatial coordinates, camera trajectories, temporal information, lighting definitions, and/or other properties defined in the 3D representation. As a result, objects in these variants can maintain stable identities, positions, physical relationships and/or other information across successive frames, preventing geometric drift, identity loss, discontinuous motion, and/or other defects. In variants, the system can enforce consistency at multiple levels of video structure, such that stylistic parameters, scene definitions, and object-level attributes remain coherent throughout shots, sequences of shots, and/or extended video segments. Through this combination of structural constraints, persistent object association, and hierarchical control, variants of the system can generate video content that maintains spatial, temporal, and visual coherence.

The database 100 functions to store object models, assets, and/or any other data for generating a shot, scene, or film. The database 100 can be a monolithic datastore (e.g., monolithic database), segmented datastore (e.g., different databases for different users, different geographic regions, different topics, etc.), and/or otherwise constructed. The database 100 can be implemented as a distributed set of databases across multiple devices or locations, or alternatively in a singular device and/or location. The database 100 can be implemented as a relational database, a graph database, a key-value store, a hybrid thereof, and/or using another suitable implementation. The data can be associated with identifiers, data and/or asset type, asset parameters, and/or other metadata. The data can be indexed using one or more indexing structures. Examples of indexing structures that can be used can include hash-based, tree-based, graph-based, or approximate nearest neighbor indices.

The database 100 can store assets. Examples of assets can include object models, character models, cosmetic models, animations, environmental assets and/or any other assets. The models can include 3D models, geometric representations, CAD files, skeletons, rigs, meshes, and/or any other suitable digital representations of objects or characters. The animations can include idle animations, locomotion animations, interaction animations, gesture animations, physics-driven animations, and/or any other suitable animations. In variants, the database 100 can include metadata. Examples of metadata can include asset identifiers, asset type information, file format information, authoring or source information, creation timestamps and/or modification timestamps, compatibility information, physical properties (e.g., size, scale, bounding volumes), semantic labels or tags, performance characteristics, and/or any other metadata.

In variants, the database 100 can store visual representations and/or visual references. In variants, the visual representations and/or visual references can be used to define how a 3D model is rendered in the visual content (e.g., frame, shot, sequence, film, video, etc.). Examples of visual representations and/or reference can include images (e.g., reference images, concept art, etc.), multi-view image sets, image embeddings (e.g., feature vectors extracted from reference images using vision encoders), identity embeddings (e.g., face-recognition or person-specific latent vectors), style embeddings (e.g., embeddings capturing visual style, lighting, texture, or color characteristics), material definitions (e.g., PBR material parameter sets: albedo, roughness, metallic maps), photogrammetry data, facial blendshape parameter sets, morph target data, Low-Rank Adaptation (LoRA) matrices, meshes (e.g. photogrammetry-derived, etc.), and/or any other visual representations and/or reference.

However, the database 100 may be otherwise configured.

The user interface 200 functions to enable a user to interact with the platform and visualize content. The user interface 200 can allow the user to interact with a variety of tools and/or perform a variety of tasks. The user interface can include a conversational interface (e.g. chat box, etc.) with agents, an asset library (e.g., for browsing assets), a 3D scene editor (e.g., for placing 3D models into a scene, for adding animations, for placing and/or moving virtual camera, etc.), a storyboard interface (e.g., for viewing shot, scene, and/or sequences of a film, etc.), a timeline editor, generative model control interfaces (e.g., for controlling generative model parameters, etc.), a visual content viewer (e.g., for viewing rendered frames, shots, videos, etc.), and/or any other interface. For example, the conversational interface can receive natural language input for producing content.

Using the user interface 200, a user can create a 3D representation and/or scene, a shot of the 3D representation, a sequence of one or more 3D representations, and/or a film. In variants, a user can define a style and/or set of style parameters of a shot, scene, sequence, and/or film in the user interface 200. Examples of style parameters can include rendering style (e.g., cartoon, photorealistic, anime, etc.), lighting, color grading, and/or any other style parameters. In a variant, a visual style can be defined by a user for a single shot or scene, and be automatically associated with a film and/or sequence. In a second variant, a user can define a style of an entire film, and the style can be automatically assigned to every shot, scene, and/or sequence. In a third variant, a user can define a style for any shot and/or scene. By allowing a user to define style across an entire film, the system can ensure visual consistency across every frame, shot, and/or scene.

In variants, the user interface 200 includes a 3D representation editor. The 3D representation editor functions to enable a user to edit a 3D representation and/or scene. The 3D representation can include a set of 3D models, animations, a virtual camera, lighting assets, and/or any other 3D representation components. In variants, the 3D representation can include the pose, scale, temporal information, animations, metadata, style parameters, and/or any other data of the assets in a scene. The 3D representation editor can be configured to receive user inputs for modifying a 3D scene, visualize a 3D representation and/or scene, modify object placement, orientation, scale, and/or properties, manage scene composition, camera placement, and lighting, and/or be otherwise configured. The user inputs can include natural language prompts, user clicks, cursor movement, and/or any other user inputs.

In variants, a 3D representation and/or scene can be manually generated (e.g., by a user) or automatically generated (e.g., using a model, and/or any other methods). In an example, a user can manually add, position, and/or animate 3D models in a scene using the 3D representation editor. In another example, the 3D representation can be automatically generated using a machine learning model (e.g., based on a natural language prompt, etc.). In a third example, the 3D representation can be automatically generated then edited by a user.

In variants, the 3D representation can be static or dynamic. For example, the 3D representation can include a still of a scene or describe temporal information of the scene (e.g., including camera trajectory motion, 3D model animations, and/or any other animations). In an example, the 3D representation can include shots and/or sequences of a scene.

However, the 3D representation editor may be otherwise configured.

However, the user interface 200 may be otherwise configured.

The set of modules functions to perform tasks for generating content. The set of modules can include machine learning models (e.g., neural networks, convolutional neural networks, deep neural networks, recurrent neural networks, transformers, etc.), language models (e.g., LLMs, etc.), generative models (e.g., diffusion models, transformer-based models, autoregressive models, etc.), and/or any other suitable models (e.g., deterministic models, physical models, camera models, etc.). In variants, each module can include a single model or a plurality of models. For example, a module can include a language model for processing natural language prompt inputs (e.g., encoding natural language inputs, etc.) and generative models for producing content (e.g., frames, shots, scenes, films, videos, and/or any other content) based on the natural language prompts.

A module can include one or more models for generating content (e.g., frames, video, etc.). For example, a transformer model can be used to generate initial representations (e.g., low resolution representation, scene graphs, object bounding maps, segmentation maps, and/or any other representations) while a diffusion model can produce the final content (e.g., by rendering pixels consistent with the initial representation, by adding textures and lighting, fine-tuning specific segments based on user input, and/or any other content production methods). The set of modules can include any other algorithms, operations, tooling (e.g., for processing and/or producing visual content), and/or any other components.

In variants, the set of modules includes a frame generation model 300 and a video generation model 500.

The frame generation model 300 functions to generate and/or render a frame. The frame generation model can be configured to generate (e.g., render) a frame based on the 3D representation (e.g., projected geometry, depth maps, camera parameters, lighting parameters), virtual camera capture data, one or more visual representations (e.g., LoRA matrices, identity embeddings, style embeddings, material definitions), user inputs (e.g., natural language prompts, parameter adjustments), visual settings and/or style parameters, metadata associated with the assets, model parameters, and/or any other basis. In variants, the style parameters used to generate a frame can be style parameters specified for a corresponding shot, scene, sequence, and/or film.

In variants, the frame generation model 300 can include a plurality of distinct generative models, where different generative models can be dispatched to render different objects within the same frame. Each generative model can be tuned, trained, optimized, and/or otherwise configured to render a frame and/or portions of a frame associated with different object classes, rendering styles, visual domains, and/or any other rendering characteristics. In other variants, the frame generation models can include generative models that are trained for general use. For example, a first generative model specialized for rendering human subjects can be associated with 3D object models of type “person,” while a second generative model specialized for rendering vehicles can be associated with 3D object models of type “car.” The association between a generative model and an object model can be determined based on the object type, object category, a user selection, a performance metric associated with the generative model for the object type, a routing model that evaluates object attributes and selects an optimal generative model, and/or any other suitable method. In these variants, the mask-based sequential rendering pipeline (e.g., S320-S340) can orchestrate the rendering order and compositing, where each object can be rendered by its respective associated generative model within the masked region corresponding to that object. The outputs of the different generative models can be composited into a single frame through the sequential mask-based infilling process.

In variants, the plurality of generative models can be arranged in a cascade architecture, where one or more object-level generative models render individual objects within their respective masked regions, and a style-level generative model subsequently processes the composite frame to apply global stylistic parameters, harmonize the visual outputs of the different object-level models, and/or ensure visual coherence across the frame. For example, a first pass can render each object using domain-specialized models (e.g., a human-specialized model, an architecture-specialized model, a natural environment model, vehicle-specialized model, animate object model, inanimate object model, etc.), and a second pass can apply a style model that adjusts lighting consistency, color grading, artistic style, and/or other visual attributes across the full frame. The cascade can include any number of processing stages, arranged sequentially, hierarchically, and/or in any other suitable configuration.

In variants, the plurality of generative models can include models of different architectures (e.g., diffusion models, transformer-based models, generative adversarial networks, variational autoencoders, autoregressive models, hybrid architectures, etc.). The generative models can reconcile outputs from heterogeneous model architectures through latent space alignment, resolution normalization, color space harmonization, and/or any other suitable reconciliation method. In these variants, each generative model can receive, as input, the object mask, one or more object rendering parameters (e.g., LoRA matrices, reference images, reference videos or video sequences, latent feature vectors, adapter weights, video references, structured metadata, generative models, combinations thereof, etc.), the 3D representation or projection thereof, visual settings, and/or any other suitable conditioning data.

In variants, the frame generation model 300 can generate a frame based on additional instruction from a user. In an example, a user can provide natural language prompts describing preferences on how the frame is generated. The user instructions can include information related to rendering style, coloring, object descriptions, and/or any other suitable information. For example, along with the 3D representation, defined style parameters, and/or any other predetermined information, a user can pass an additional natural language prompt to the frame generation model 300. Examples of prompts can include “generate the frame with very dark, moody lighting”, “generate the frame so that the man on the right looks like Reference Image A”, “generate the frame with a vintage style filter”, and/or any other prompts. However, any additional information can be used to generate a frame.

The frame generation model 300 can generate one frame, a plurality of frames, and/or any number of frames. In an example, the frames generated can be specified by a user (e.g., based on the 3D representation, based on a timeline, and/or any other specifications). In an example, a user can select specific timestamps and/or keyframes (e.g., snapshots, captures, instantaneous captures, etc.) along a timeline of the 3D representation, to be generated. In another example, the frame generation model 300 can generate frames of the 3D representation at a specified and/or predetermined sampling rate. In a third example, the frame generation model 300 can adaptively generate frames based on the 3D representation. For example, temporal segments of the 3D representation that have more motion may be sampled for frames at a higher rate. The frames can be generated according to any suitable sampling strategy, including user-defined, rule-based, model-driven, hybrid approaches, and/or any other approaches. However, the frame generation model 300 can generate frames based on any suitable method.

In a variant, the input of the frame generation model 300 can include the 3D representation, style parameters, visual representations and/or references (e.g. associated with specific 3D models of the 3D representation, etc.), a set of timestamps associated with frames of interest, virtual camera data, keyframes (e.g., time-specific, viewpoint depictions of 3D representations), and/or any other input. The frame generation model 300 can include a single model (e.g., generative model, etc.) or a plurality of models (e.g., generative models, etc.). A plurality of models can be arranged sequentially, hierarchically, or in parallel. For example, the frame generation model 300 can include a generative model for generating an initial frame and a second generative model for modifying the frame.

In variants, the frame generation model can generate an intermediate representation (e.g., initial frame, latent tensor, segmentation map, scene graph, bounding map, low-resolution frame), generate a final frame based on the intermediate representation, and/or otherwise function.

In variants, the frame generation model 300 can generate a complete frame or generate and/or modify portions and/or segments of a frame (e.g., based on a mask). In variants, modifying a segment of a frame can include generating a mask corresponding to a segment (e.g., using a mask generator), regenerating only pixels within the mask, preserving pixels outside the mask, conditioning regeneration on object-specific visual representations (e.g., LoRA matrices, identity embeddings), conditioning regeneration on style parameters, reference images, or material definitions, and/or any other modifications. In variants, wherein the frame generation model 300 is used to render segments of frames (e.g., rendering separate objects in a frame, etc.), the frame generation model 300 can receive, as input, the visual representation and/or references for all objects or a subset of the object. In variants, the frame generation model 300 can render each object separately, together, sequentially, based on an object rendering order, and/or any other suitable manner.

In variants, the frame generation model 300 can include a mask generator 400. The mask generator 400 functions to generate a mask for the frame. The mask generator 400 can generate one or more masks associated with a frame. In variants, the mask generator 400 can generate masks based on a 3D representation, the frame, and/or any other data representation. In variants the mask generator can receive the 3D representation, camera trajectory information, virtual camera capture data, frame information, depth maps, normal maps, depth filters, scene and/or model maps, 3D object model properties, and/or any other data.

For example, a mask can be generated based on the 3D representation by projecting one or more 3D models into a 2D image plane based on camera parameters, computing silhouette projections, computing depth-aware projections, rasterizing meshes into 2D mask representations, using bounding volumes, using segmentation maps derived from the 3D scene, and/or any other method. In variants in which the masks are generated based on the 3D representation, the masks can correspond to a 3D model, a set of 3D models, a region of interest, a background region, a depth range, and/or any other correspondence. For example, the masks can be associated with an object identity, pose, scale, and/or any other suitable information.

A frame can be generated, re-generated, and/or modified based on the mask and the object information. In variants, the mask generator 400 generating a mask based on a 3D representation can ensure that the 3D representation is the ground-truth representation of the scene, ensuring consistency across all frames of the content. For example, the generated mask can be associated with or tied to a specific 3D object model (e.g., via metadata, etc.). In these variants, generating a frame, using the mask as input, ensures that 3D object model data (e.g., pose, scale, position, etc.) is also received by the generative model. As an illustrative example, if only a segment or portion of a 3D model is within a viewing window of a frame or keyframe, by associating a mask to 3D object model data, segments and/or portions of the 3D model can be rendered appropriately based on the 3D object model data.

In another variant, the mask can be determined based on an intermediate representation (e.g., an initial frame). For example, the frame generation model can generate an initial frame. Subsequently, pixels of the frame can be re-generated (e.g., based on visual representations and/or references, LoRA, etc.) using masks generated from the initial frame.

In variants in which the mask is generated based on the frame, the mask generator model can include image processing steps, thresholding (e.g., global thresholding, adaptive thresholding, color thresholding, etc.), Canny edge detection, Sobel filters, Prewitt filters, Laplacian operators, Region growing algorithms, Watershed algorithm, superpixel clustering, K-means clustering, Gaussian mixture models, mean-shift clustering, background subtraction, machine learning models (e.g., CNNs, transformers, etc.), semantic segmentation models, and/or any other mask generator model.

The masks can be binary, soft (e.g., alpha masks), probabilistic, depth-weighted, and/or multi-channel masks. In variants, the mask can extend beyond the visible frame boundaries and/or represent occluded portions of an object. In an example, in variants in which the mask is generated based on the 3D representation, a generated frame may have a tighter field of view than an associating mask.

The mask generator can operate before frame generation (e.g., providing conditioning inputs), after initial frame generation (e.g., for selective regeneration), iteratively in conjunction with the frame generation model, and/or in any other manner.

In variants, the frame generator can generate an initial frame, generate one or more masks associated with objects or regions, sequentially re-generate masked regions using object-specific visual representations and/or references, compositing regenerated segments into the frame, and/or otherwise operate. In variants, the frame generator can modify and/or re-generate a frame based on the mask, corresponding object information (e.g., pose, scale), and a visual representation and/or reference.

However, the mask generator 400 may be otherwise configured.

However, the frame generation model 300 may be otherwise configured.

The video generation model 500 functions to generate a video. The video generation model can generate a video based on one or more key frames, 3D scene representation (e.g., shot, sequence, etc.), animation data, virtual camera data, camera trajectories, user inputs (e.g., natural language prompts, etc.), metadata, visual parameters and/or style settings, model parameters, and/or any other basis. The video generation model can generate intermediate frames (e.g., based on generated and/or rendered frames, keyframes), frame sequences, video (e.g., continuous video), encoded video files, and/or any other video content.

In variants, the video generation model 500 can include a generative model, a diffusion model, a transformer, and/or any other suitable model. In variants, the key frames can be generated using the frame generation model. In variants, the video generation model 500 can generate intermediate frames between key frames. In variants, the video generation model 500 can interpolate between keyframes, autoregressively generate frames conditioned on previous frames, generate intermediate frames using predicted motion fields, and/or generate frames using any suitable method. In some variants, the video generation model 500 can perform optical flow-based interpolation, phase-based interpolation, trajectory-based interpolation, and/or any other operation. In variants, the video generation model can ensure visual consistency by conditioning on prior frames, conditioning on object identity embeddings, conditioning on projected 3D geometry across time, using optical flow constraints, using temporal attention mechanisms, enforcing depth consistency across frames, and/or otherwise ensuring visual consistency. In variants, the video generation model can operate in pixel space, operate in latent space, operate on compressed video tokens, operate using hierarchical generation (e.g., low-resolution sequence generation followed by refinement), and/or otherwise operate.

In some variants, the video generation model 500 can perform visual comparison between generated intermediate frames and the 3D representation. For example, the 3D representation can be projected onto 2D planes based on the camera trajectory to determine reference frames. These reference frames can be compared to the intermediate frames generated by the video generation model 500 using IoU, pixel-wise metrics, mean squared error, root mean squared error, mean absolute error, peak signal-to-noise ratio, structural similarity, learned feature-based metrics, optical flow and/or motion consistency metrics, and/or any other metric. In variants, if a generated intermediate frame is not consistent with the 3D representation and/or the reference frame, the intermediate frame may be regenerated by the video generation model 500.

The video generation model 500 can perform post-processing steps. Examples of post-processing steps can include ordering the frames, concatenating the frames, encoding the stream into a selected video container format, temporal smoothing (e.g., reducing frame-to-frame jitter or flicker), motion stabilization, color normalization, exposure harmonization, spatial filtering to reduce artifacts introduced during interpolation or regeneration, applying film visual settings, and/or any other post-processing steps.

However, the video generation model 500 may be otherwise configured.

However, the set of modules may be otherwise configured.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A method comprising:
determining a 3D representation comprising a set of 3D object models and temporal information;
determining a set of visual parameters;
determining a set of instantaneous captures of the 3D representation, wherein each instantaneous capture comprises the 3D representation from a viewing direction at a temporal state based on the temporal information;
generating a set of keyframes using a set of models, wherein generating each keyframe of the set of keyframes comprises, for each instantaneous capture:
determining projections of the 3D object models onto a 2D plane at a respective viewing direction; and
rendering the keyframe using a subset of the set of generative models based on the 3D representation, the projections, and the visual parameters; and
generating a video based on the set of keyframes using a diffusion model.

2. The method of claim 1, wherein the set of visual parameters comprises a set of object rendering parameters, wherein each object rendering parameter of the set of object rendering parameters corresponds to a different 3D object model of the set of 3D object model, wherein generating the set of keyframes comprises rendering each 3D object model based on a corresponding object rendering parameter.

3. The method of claim 2, wherein the object rendering parameters comprises at least one of reference images, reference videos, latent feature vectors, adapter weights, structured metadata, or low-rank adaptation matrix associated with a predetermined person.

4. The method of claim 1, wherein the set of generative models comprises a human generative model, a vehicle generative model, and a frame style model.

5. The method of claim 1, wherein rendering the keyframes comprises, for each keyframe:
determining the 3D object models represented in the keyframe;
for each 3D object model represented in the keyframe, rendering a portion of the keyframe using at least one model of the set of generative models based on an object type of the 3D object model; and
compositing the portions of the keyframe.

6. The method of claim 5, wherein rendering the keyframes further comprises, after compositing the portions of the keyframe, applying a style model to the composited frame.

7. The method of claim 1, wherein generating a video comprises interpolating frames between the set of keyframes, wherein the interpolated frames comprise 2D representations of the 3D object models that are visually consistent with the 3D representation.

8. The method of claim 1, wherein at least one instantaneous capture of the set comprises only a subset of the 3D object models within a viewing window, wherein the at least one instantaneous capture comprises metadata associated with all 3D object models of the 3D representation.

9. The method of claim 1, wherein generating each keyframe of the set of keyframes further comprises, for each instantaneous capture:
using the generative model, generating a preliminary keyframe based on the set of visual parameters and the respective instantaneous capture;
determining a set of masks based on the projections, wherein each mask is associated with a 3D object model;
generating the keyframe comprising modifying a section of the preliminary keyframe corresponding to at least one mask of the set of masks based on an object rendering parameter using the generative model.

10. The method of claim 9, wherein modifying the section of the preliminary frame comprises modifying the section without modifying other sections of the frame.

11. The method of claim 1, wherein each 3D object model is associated with a persistent object identifier that is maintained as metadata across the set of keyframes.

12. The method of claim 1, wherein generating the video comprises generating a second set of keyframes using the same set of visual parameters used to generate the set of keyframes and concatenating the set of keyframes with the second set of keyframes, wherein the video is generated based on the concatenated set of keyframes.

13. The method of claim 12, wherein the set of visual parameters are automatically applied when generating the second set of keyframes.

14. A method comprising:
determining a 3D representation comprising a set of 3D object models, wherein each 3D object model is associated with an object rendering reference;
determining a shot of the 3D representation, wherein the shot comprises a virtual camera trajectory within the 3D representation;
determining a set of instantaneous captures of the shot;
generating a set of rendered keyframes, comprising, for each instantaneous capture:
rendering an intermediate keyframe using a generative model;
determining a mask of at least one of the set of 3D object models based on the 3D representation, wherein the mask is not determined based on the intermediate keyframe; and
generating a fully rendered keyframe comprising re-generating a segment of the intermediate keyframe associated with the mask based on an object rendering reference associated with the mask; and
generating a video based on the set of fully rendered keyframes.

15. The method of claim 14, wherein each object rendering reference comprises at least one of a reference image, a video sequence, a set of adapter weights insertable into the generative model, a latent feature vector, or a set of structured metadata describing visual attributes of the corresponding object.

16. The method of claim 15, wherein the latent feature vector is determined by processing image data of the corresponding object through an embedding model.

17. The method of claim 14, wherein determining the mask for each instantaneous capture comprises projecting the at least one 3D object model on a 2D plane in a direction associated with the respective keyframe.

18. The method of claim 14, wherein re-generating the segment of the intermediate keyframe associated with the mask is performed iteratively for each 3D object model of the set of 3D object models.

19. The method of claim 14, re-generating the segment of the intermediate keyframe associated with the mask is performed using an object-specific generative model optimized to render a 3D object model type associated with the segment of the intermediate keyframe, wherein the object-specific generative model is fine-tuned using training data associated with the 3D object model type.

20. The method of claim 14, further comprising determining a sequence of shots of the 3D representation and generating a set of fully rendered keyframes for each shot of the sequence using the same set of visual parameters.
